(19) United States
(12) Patent Application Publication
(10) Pub. No.: US 2004/0219679 A1
(43) Pub. Date: Nov. 4, 2004

(54) Apparatus for determining constitution of human being by use of ring-shaped figure image of red blood cell

(75) Inventors: Kenji Sato, Hamamatsu-shi (JP); Hideki Hirabayashi, Yokkaichi-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignees: Kabushiki Kaisha Instem; Kabushiki Kaisha Genki Club

(21) Appl. No.: 10/819,566

(22) Filed: Apr. 7, 2004

Related U.S. Application Data
(63) Continuation of application No. PCT/JP02/10439, filed on Oct. 7, 2002.

(30) Foreign Application Priority Data
Oct. 11, 2001 (JP) 2001-313547
Jul. 11, 2002 (JP) 2002-203031

(51) Int. Cl. G01N 31/00

(52) U.S. Cl. 436/63

(57) ABSTRACT

With the object of properly classifying a flat-shaped red blood cell in the blood of a human being to thereby determine the constitution of the human being, an outer diameter of a ring-shaped figure corresponding to a diameter d of the red blood cell, and a width of the ring-shaped figure corresponding to a thickness t of a cell membrane of the red blood cell are extracted as the features of the red blood cell, on the basis of red-blood-cell image data produced for allowing a portion of a cross section of the red blood cell to be obtained by cutting the red blood cell in a direction of the plane of the red blood cell, to be visualized as the ring-shaped figure, wherein the portion corresponds to the cell membrane, and the red blood cell is classified as one of a predetermined plurality of types of red blood cells including an expansion, a contraction, and a medium type, on the basis of the extracted features.

### CROSS-REFERENCE TO RELATED APPLICATIONS

This is a continuation of Application PCT/JP02/10439 filed Oct. 7, 2002, which was published in Japanese under PCT Article 21(2).

This application is based on Japanese Patent Applications No. 2001-313547 filed Oct. 11, 2001, and No. 2002-203031 filed Jul. 11, 2002, the contents of which are incorporated hereinto by reference.

### BACKGROUND OF THE INVENTION

1. Field of the Invention

The present invention relates to techniques for determining the constitution of a human being.

2. Description of Related Art

It has been widely said that there is a constitution for a human being. Originally, each one of individual human beings retains his or her constitution inherent to himself or herself, and therefore, more precisely, a plurality of human beings cannot share the same constitution. However, several existing theories that have been proposed allow classification of the constitutions of all human beings into a limited number of types.

Recently, there has been indicated the strong relationship between foods that human beings eat and illness that human beings face. Described particularly, by way of example, the national report presented by the Government of the United States of America in 1970s, called “McGovern's Report,” addressed that the diseases which form six major causes of death such as cancer are recognized as “food-caused diseases,” meaning that all diseases are by root caused by foods.

Additionally, as an example, in 1992, in collaboration with the Ministry of Health, Labor, and Welfare in the United States of America, the United States Department of Agriculture categorized the proper foods that human beings should eat into five groups, for the purpose of presenting the dietary and lifestyle guidelines toward the twenty-first century, resulting in the creation of the food pyramid indicating the quantities of the proper foods that human beings should eat, for each one of the above groups. The guidelines pointed out that a food is capable of functioning as a factor for causing diseases, and also as a factor for preventing diseases.

Although the prevention of a disease therefore requires human beings to eat the foods suitable for the purpose, it has been already pointed out, in addition to the above, that an issue of whether or not a food is suitable for each individual's eating depends on his or her constitution.

Thus, it has been said that it is important for each individual to learn his or her constitution, from the perspective of practicing a proper diet and lifestyle and preventing diseases, and that it is also important from the perspective of mentally and spiritually normalizing each individual.

Furthermore, it is also important for each individual to learn his or her constitution, from the perspective of quick recovery, maintenance, improvement, etc., of each individual's health, for example.

It is possible to basically classify the constitutions of human beings into three types. This will be described in more detail below.

In general, when a substance is heated to incandescence or to vaporization (or plasma), the substance emits light. The wavelength of the emitted light varies according to the kinds of elements constituting the substance. As one example of the approach to perform the qualitative and quantitative analysis of an element by taking advantage of the above-described property, there is known the spectroscopic analysis employing the spectrum of an element to be analyzed. In this spectroscopic analysis, the wavelength of light emitted from an element to be analyzed reflects the nature of the element.

An element can be categorized depending upon the magnitude of a centripetal force of a proton, i.e., a force permitting a proton to attract an electron in the element. That is, an element can be categorized into one having a strong centripetal property (i.e., a property to move toward the center) due to a large centripetal force of the proton; and one having a strong centrifugal property (i.e., a property to move away from the center) due to a large centrifugal force of the proton.

After an extremely high thermal energy is added to an element, when the amount and the strength of the thermal energy each exceed a threshold level, the thermal energy is converted into light energy, resulting in the emission of a photon from the element. The photon travels at a high speed in space in a spiral rotary motion. When the movement of the photon is observed perpendicular to the traveling direction of the photon, the track along which the photon moves forms a wave. The length of the repetition unit of the wave is referred to as wavelength.

On the other hand, in the case of a small centripetal force of a proton in an element, the orbit along which an electron revolves in the element is large in diameter, and also the revolution speed is high.

At the emission of a photon from one element, a high revolution speed of its electron is accompanied by a high revolution speed of the photon. Due to the speed of light being constant, a high revolution speed of the photon is accompanied by both a large number of revolutions thereof, and a high density of the wave thereof. The high density is accompanied by both a large number of the repetition units of the wave of the photon, and a short wavelength thereof. The shorter the wavelength is, the higher the frequency of the wave is, and therefore, the amount of vibration energy of the photon is larger, resulting in a large force of the photon acting on other substances.

Therefore, in general, the stronger the centrifugal property of a proton is, the higher the revolution speed of an electron is, and the larger the acting force of the photon is.

Now, while an element which is shorter in the wavelength of light emitted from the element, and which is stronger in the centrifugal property is referred to as “yin-natured element,” an element which is longer in the wavelength of light emitted from the element, and which is stronger in the centripetal property is referred to as “yang-natured element.”

An element emitting light whose wavelength ranges from 3, 500 to 5,000 angstrom, i.e., an element whose wavelength is shorter, is classified as the above yin-natured element with its strong centrifugal property. The examples are such as potassium, oxygen, phosphorus, nitrogen, sulfur, calcium, etc. Alternatively, an element emitting light whose wavelength ranges from 5,000 to 8,000 angstrom, i.e., an element whose wavelength is longer, is classified as the above yang-natured element with its strong centripetal property. The examples are such as sodium, hydrogen, carbon, magnesium, etc.

It is added that the values of the above-mentioned wavelengths have been deprived from data disclosed in the atlas appearing typical photographs of spectrum, titled “ATLAS TIPISCHEN SPECTREN,” co-authorized by Dr. J. M. Adair and Prof. Y. E. Valenta; and the literature titled “Table of Spectrum,” authorized by Keisel. These values are addressed in the literature titled “MUSOGENRI•EKI (MONISM•DIVINATION),” authored by SAKURAZAWA Yukikazu, published by Japan CI Association.

As widely known, fundamental elements constituting a human body begin with oxygen, carbon, hydrogen, nitrogen, calcium, phosphorus, sulfur, potassium, sodium, chlorine, magnesium, etc., eventually consisting of approximately fifty kinds of elements. As described above, each element retains, with regard to its proton, both the centripetal property, i.e., yang-nature, and the centrifugal property, i.e., yin-nature, which are considered as two properties (or tendencies) contrary to each other. However, each element is biased toward either of the yang- or the yin-nature. Accordingly, it follows that each element apparently represents the more dominant of the yang- and the yin-nature. That is, the nature of each element depends on the difference in strength between the yang- and the yin-nature included in the each element.

A human body is constructed by combining an immense number of elements and by highly organizing them. Accordingly, both whether the whole of the elements constituting a human body is biased to either the yin- or the yang-nature, and how strong the bias is determine the nature of the entire of the above organization, namely, the constitution which the human being bears.

As will be readily understood from the above that, eventually, the constitution of a human being can be basically classified into the yin- and the yang-nature, and a medium-nature meaning the intermediate nature between the yin- and the yang-nature.

The major roles which the blood of a human being plays include: the conveyance of necessary substances into various pieces of the tissue of the human body; and the conveyance of waste substances into the excretion organ of the human body. The major roles further include: the removal of substances harmful to the human body, germ, etc.; the protection of the mode of life of the human body; the maintenance of the homeostasis of the inside environment of the human body; an even maintenance of the body temperature over the entire human body; and so on.

The blood consists of a liquid component, i.e., blood plasma; and a cell component floating in the blood plasma. The blood plasma occupies approximately 55 percent of the total blood, which is made up of water, protein, blood sugar, lipid, inorganic salt and the like, nitrogen combination, and so on. Alternatively, the above cell component occupies approximately 45 percent of the total blood, which is made up of the red blood cell, the white blood cell, the blood platelet, and so on.

The red blood cell is formed as a flat blood cell with a diameter of approximately 8 μm. The major component of the red blood cell is the hemoglobin contributing to the conveyance of oxygen and carbon dioxide, and to the maintenance of the acid-base equilibrium. The red blood cell contains various kinds of the blood group substances, thereby determining the blood group or blood type of each human being.

There is known the term “blood image or blood picture.” This term, meaning the nature and condition of the cell component of the blood, is used when collectively indicating: the number, shapes, and sizes of the red blood cells; the number of the white blood cells; the abundance ratio per kind; whether or not a morphological abnormality is present; etc. It has been said that the above blood image is useful in performing diagnosis of a human being, because of the nature of the blood image that it changes depending upon the kind of sickness that a human being suffers.

The technique for automatically analyzing the shape of a red blood cell using the image or picture of the red blood cell has been already proposed. One conventional approach of the technique is described in Japanese Publication No. Hei 8-304390.

According to the above conventional approach, the image of a plurality of red blood cells distributed two-dimensionally is picked up as a still image or picture. The digital data of the picked-up image undergoes a Fourier transform, thereby to calculate a Fourier spectrum. Based on the calculated Fourier spectrum, parameters relating to the number and/or the shapes of the red blood cells are analyzed.

In the above-mentioned Japanese Publication, the “parameter relating to the number of red blood cells” is, for example, the density of red blood cells, and the “parameter relating to the shapes of red blood cells” is, for example, a mean corpuscular diameter (MCD), a mean corpuscular volume (MCV), or the like.

Japanese Publication No. Hei 10-48120 discloses one conventional technique for correctly distinguishing red blood cells and white blood cells from each other based on a picked-up image of the red and the white blood cells in urine. This conventional technique utilizes, for each image picked up of a particle, both a parameter R representing the ratio of the concentration of the center part of the particle to the concentration of the peripheral part of the particle, and a parameter S representing the dispersion of the concentration between light and shade inside of the particle.

### BRIEF SUMMARY OF THE INVENTION

The present inventors have conducted a study on techniques for determining the constitution of a human being using the nature and condition of red blood cells in the blood of the human being. As a result, the present inventors have obtained the finding that the classification of red blood cells is correlated with the classification of constitutions. The experimental data demonstrating the results of the above study will be described in more detail later.

Further, the present inventors have also obtained the finding that it is important to pay attention to both the size, i.e., the diameter of a red blood cell, and the thickness of a cell membrane of the red blood cell, in order to properly classify the red blood cell for determining the constitution of a human being.

In contrast with the above findings, none of the aforementioned two Japanese Publications teaches utilizing the classification results of red blood cells for determination of the constitution of a human being. Further, none of the two Japanese Publications teaches that it is important to pay attention to both the diameter of a red blood cell and the thickness of a cell membrane of the red blood cell in order to properly classify the red blood cell for determination of the constitution of a human being.

Based on the above-mentioned findings obtained by the present inventors, the present invention has been made to achieve an object of properly classifying a red blood cell for determination of the constitution of a human being.

The following modes are provided according to the present invention. These modes will be stated below such that these modes are sectioned and numbered, and such that these modes refer to the number(s) of other mode(s), where appropriate. This is for a better understanding of some of a plurality of technical features and a plurality of combinations thereof disclosed in this description, and does not mean that the scope of these features and combinations is interpreted to be limited to the scope of the following modes:

(1) An apparatus for determining a constitution of a human being, comprising:

a feature extraction means for extracting an outer diameter of a ring-shaped figure corresponding to a diameter of the red blood cell, and a width of the ring-shaped figure corresponding to a thickness of a cell membrane of the red blood cell, as features of a red blood cell in blood of the human being, on the basis of red-blood-cell image data representing a two-dimensional image of the red blood cell which is flat-shaped on a plane and which is enclosed by the cell membrane having the thickness, wherein the red-blood-cell image data is produced for allowing a portion of a cross section of the red blood cell to be obtained by cutting the red blood cell in a direction of the plane, to be visualized as the ring-shaped figure, wherein the portion corresponds to the cell membrane;

a red-blood-cell classification means for classifying the red blood cell as one of a predetermined plurality of types of red blood cells, on the basis of the extracted features, wherein the plurality of types includes an expansion type where a red blood cell exhibits an expansion tendency, a contraction type where a red blood cell exhibits a contraction tendency, and a medium type which is intermediate between the expansion and the contraction type, as three basic types of red blood cells; and

a constitution determination means for determining the constitution of the human being as one of a predetermined plurality of types of constitutions of human beings, on the basis of one of the plurality of types of red blood cells as which the red blood cell has been classified.

FIGS. 16 to 27 show respective images of red blood cells in blood samples collected from the bodies of a plurality of human beings, in the form of a micrograph taken, upon observation, under a phase-contrast microscope.

These micrographs have been taken by observing the red blood cells in dark field. The dark field observation is performed under the condition where, other than an illuminating light from a light source of the microscope, a scattered light from the red blood cells, i.e., the samples, enters the object lens of the microscope. As a result, a red blood cell is photographed such that, while a cell membrane portion of the red blood cell (a solid portion) is lightened up in the dark background, an inner portion of the red blood cell (a liquid portion, i.e., blood plasma) is darkened. Each micrograph has been obtained by photographing each real red-blood-cell at a magnification of approximately ×10,000.

The above dark field observation enables a technique of sharply photographing an outer and an inner circumferential plane of a cell membrane within a cross section of a red blood cell obtained by conceptually cutting the red blood cell parallel to a direction in which the red blood cell is flat-shaped, resulting in improvement of a technical easiness in precisely measuring of a thickness of the cell membrane.

FIGS. 16, 20, and 24 show the respective micrographs that were taken of the respective blood samples, immediately after being collected from the bodies of respective human beings, while FIGS. 17, 18, 19, 21, 23, 25, and 27 show the respective micrographs that were taken of the respective blood samples after being cultured under a predetermined condition. Apparently from these micrographs, red blood cells have a plurality of types in size and shape.

It is added that the micrographs of the red blood cells taken immediately after collection of the blood samples were taken under the following conditions:

Immediately after the blood (i.e., the whole blood) has been collected as a sample from the fingertip of the subject human being, the collected blood is put on a slide glass as expeditiously as possible, and subsequently, the collected blood is covered with a cover glass. Besides that, the periphery of the cover glass is sealed with oil for a microscope to perform an oil immersion, whereby the above micrographs were taken under the anaerobic condition where the collected blood is isolated from oxygen.

For culturing the red blood cells, the thus prepared blood samples are stored within an incubator (a device to culture) at a temperature of 38 degrees centigrade. The blood samples are stored within the incubator for a predetermined period of time (e.g., three days, several days, one week, two weeks).

A red blood cell can be generally classified depending upon its size and shape, into the following three basic types:

an expansion type where a red blood cell exhibits an expansion tendency (the blood cell is larger in diameter, and its cell membrane is thinner);

a contraction type where a red blood cell exhibits a contraction tendency (the blood cell is smaller in diameter, and its cell membrane is thicker); and

a medium type situated between the above two types.

When FIGS. 16, 20, and 24 showing the respective micrographs taken immediately after collection of red blood samples are attempted to be classified as one of the expansion, the contraction, and the medium type according to the above-mentioned classification rule, the micrographs of FIGS. 16, 20, and 24 are classified as the expansion, the medium, and the contraction type, respectively.

Thus, it is observed that the nature and condition of the red blood cell immediately after collected from a human body would allow classification of the red blood cell as one of three basic types consisting of the expansion, the contraction, and the medium type. In addition, it is also observed that the nature and condition of the red blood cell whose property has been enhanced by culturing the collected red blood cell would allow classification of the red blood cell as a type other than the three basic types. This will be described in greater detail below.

In the case of a red blood cell which has been determined to be the expansion type in view of a micrograph of the red blood cell taken immediately after collected from a human body, as shown in FIG. 16, there may arise, after culturing the collected blood cell: the instance where the red blood cell shows a strong-expansion tendency, as shown in FIG. 17; the instance where the red blood cell shows a normal-expansion tendency, as shown in FIG. 18; and the instance where the red blood cell shows not only an expansion tendency but also a contraction tendency, as shown in FIG. 19.

The finding that the red blood cell shows a strong-expansion tendency in FIG. 17 has been derived from the fact that it is observed from FIG. 17 that the red blood cell has been expanded, resulting in a large number of red blood cells with thinner cell membranes during the course of the hemolysis. Moreover, the finding that the red blood cell shows a normal-expansion tendency in FIG. 18 has been derived from the fact that it is observed that, unlike in FIG. 17, there are few red blood cells during the course of the hemolysis. Furthermore, the finding that the red blood cell shows not only an expansion tendency but also a contraction tendency in FIG. 19 has been derived from the fact that it is observed that the red blood cell has a large number of dents on its cell membrane, demonstrating the presence of a contraction tendency of the red blood cells.

In addition, as shown in FIG. 20, in the case of a red blood cell which has been determined to be the medium-type in view of the micrograph of the red blood cell taken just after collected from a human body, there may arise, after culturing the red blood cell: the instance where the red blood cell shows not only a medium tendency but also an expansion tendency, as shown in FIG. 21; the instance where the red blood cell shows a normal-medium tendency, as shown in FIG. 22; and the instance where the red blood cell shows not only a medium tendency but also a contraction tendency, as shown in FIG. 23.

The finding that the red blood cell shows not only a medium tendency but also an expansion tendency in FIG. 21 has been derived from the fact that it is observed from FIG. 21 that the red blood cell has been dilated, demonstrating the presence of a expansion tendency of the red blood cell. Moreover, the finding that it is observed that the red blood cell normally shows a normal-medium tendency in FIG. 22 has been derived from the fact that, unlike in FIG. 21, there are red blood cells having neither an expansion tendency nor a contraction tendency. Furthermore, the finding that the red blood cell shows not only a medium tendency but also a contraction tendency in FIG. 23 has been derived from the fact that it is observed that the red blood cell has a large number of dents on its cell membrane, demonstrating the presence of a contraction tendency of the red blood cell.

In addition, as shown in FIG. 24, in the case of a red blood cell which has been determined to be the contraction type in view of the micrograph of the red blood cell taken immediately after collected from a human body, there may arise, after culturing the red blood cell: the instance where the red blood cell shows a strong-contraction tendency, as shown in FIG. 25; the instance where the red blood cell shows a normal-contraction tendency, as shown in FIG. 26; and the instance where the red blood cell shows not only a contraction tendency but also an expansion tendency, as shown in FIG. 27.

The finding that the red blood cell shows a strong-contraction tendency in FIG. 25 has been derived from the fact that it is observed from FIG. 25 that, as a result of the red blood cell having a strong-contraction tendency and its cell membrane being thicker, there are a large number of red blood cells whose cell membranes have been reduced in transparency. Moreover, the finding that the red blood cell shows a normal-contraction tendency in FIG. 26 has been derived from the fact that it is observed that there are few red blood cells each having a strong-contraction tendency. Furthermore, the finding that the red blood cell shows not only a contraction tendency but also an expansion tendency in FIG. 27 has been derived from the fact that it is observed that, due to the occurrence of an expansion tendency of the red blood cell, the diameter of the red blood cell has been increased.

As will be apparent from the foregoing explanation, the consideration of the nature and condition of a cultured red blood cell reveals that the types of red blood cells include three basic types: a normal-expansion type, a normal-medium type, and a normal-contraction type; and a plurality of combination types obtained by combining some of these basic types.

The present inventors conducted experiments of 23 subject human-beings, including an experiment of determining the constitution of each subject human-being according to the theory for determining constitution described in the section of “Background Art,” and an experiment of determining (classifying) red blood cells in view of the findings of the present inventors described above by reference to the above-mentioned micrographs.

The more the constitution of a human being shows yin-nature, the more strongly the cells and the tissues of the human being show a centrifugal property expressed as expansibility in a cell named red blood cell. To the contrary, the more the constitution of a human being shows yang-nature, the more strongly the cells and the tissues of the human being show a centripetal property expressed as contractibility in a cell named red blood cell.

Then, there will be explained below the matching between the determination results of red blood cells and the determination results of constitutions for the 23 subject human-beings (the identification numbers “1” through “23” have been assigned to, respectively). In the explanation, for the simplicity of the matching, it will be presupposed that, in view of the fact that an expansion, a contraction, and a medium type of a red blood cell correspond to yin-, yang-, and medium-nature of a constitution, respectively, an expansion, a contraction, and a medium type of a red blood cell are to be classified as yin-, yang-, and medium-nature of the red blood cell, for convenience's sake.

While the determinations of constitutions of human beings were made in accordance with three separate kinds of rules, the determinations of red blood cell were made in accordance with a common rule. FIGS. 28 through 30 show three kinds of determination results of constitutions in a table in association with the determination results of red blood cells, respectively.

The determination results of constitutions shown in FIG. 28 were obtained under both the condition where the more the constitution is yin-natured, the more the elements with centrifugal properties exist within the human body, and therefore, the physical constitution (i.e., physique) of a human body bears expansibility, and the condition where, conversely, the more the constitution is yang-natured, the more the elements with centripetal properties exist within the human body, and therefore, the physical constitution of a human being has expandability.

Under these conditions, when one of the subjects corresponded to “MIZUBUTORI” meaning a fat and water-swelled human-being (the subcutaneous tissue is less elastic), the constitution of the subject was determined to be yin-nature. Conversely, when one of the subjects corresponded to “KATABUTORI” meaning a fat and stiff human-being (the subcutaneous tissue is elastic), the constitution of the subject was determined to be yang-nature. In the table of FIG. 28, the physique of each subject becomes stronger in “MIZUBUTORI” tendency when going leftward, and conversely, becomes stronger in “KATABUTORI” tendency when going rightward.

Besides that, in the table of FIG. 28, the red blood cell of one of the subjects becomes stronger in yin-nature (expansibility) when going upward, and conversely, becomes stronger in yang-nature (contractibility) when going downward. This directional arrangement applies also to FIGS. 29 and 30.

In the table of FIG. 28, per each subject, the determination result of a red blood cell is indicated in letters, and also one of a plurality of types of constitutions (indicated in letters in parenthesis) that the each subject belongs to is indicated by circle. This notation applies also to FIGS. 29 and 30. In the table of FIG. 28, a plurality of circles associated with a plurality of subjects is generally distributed along a line sloping downward when going from left to right.

The determination results of constitutions shown in FIG. 29 were obtained under both the condition where the more the constitution shows yin-nature, the more the elements with the centrifugal properties exist within the human body, and therefore, the surfaces of the cells of the human being have expansibility and are easier to radiate heat, leading to a low body-temperature, and the condition where the more the constitution shows yang-nature, the more the elements with centripetal properties exist within the human body, and therefore, the surfaces of the cells of the human being have contractibility and are hard to radiate heat, leading to a high body-temperature.

Under these conditions, when the body temperature of one of the subjects was low, the constitution was determined to be yin-nature, and conversely, when the body temperature was high, the constitution was determined to be yang-nature. In the table of FIG. 29, the body temperature of each subject becomes lower when going leftward, and conversely, becomes higher when going rightward.

Also in the table of FIG. 29, a plurality of circles associated with a plurality of subjects is generally distributed along a line sloping downward when going from left to right.

The determination results of constitutions shown in FIG. 30 were obtained under both the condition where the more the constitution shows yin-nature, the more the elements with the centrifugal properties exist within the human body, and therefore, the surfaces of the cells of the human being have expansibility and are easier to radiate heat, leading to a low blood-pressure, and the condition where the more the constitution shows yang-nature, the more the elements with the centripetal properties exist within the human body, and therefore, the surfaces of the cells of the human being have contractibility and are harder to radiate heat, leading to a high blood-pressure.

Under these conditions, when the blood pressure of one of the subjects was high, the constitution was determined to be yin-nature, and conversely, when the blood pressure of the subject was low, the constitution was determined to be yang-nature. In the table of FIG. 30, the blood pressure of each subject becomes lower when going leftward, and conversely, becomes higher when going rightward.

Also in the table of FIG. 30, a plurality of circles associated with a plurality of subjects is generally distributed along a line sloping downward when going from left to right.

As is evident from the above explanation, the results of the experiments shown in FIGS. 28 through 30 demonstrate that there is established a relationship between the determination results of constitutions and the determination results of red blood cells, wherein the relationship is represented with a line sloping downward when going from left to right. This means the validity of determining the constitution of a human being on the basis of the classification of a red blood cell of the human being.

As is apparent from the above explanation, giving attention to both the diameter of a red blood cell of a human being, and the thickness of its cell membrane would make is possible to property classify the red blood cell for determining the constitution of the human being.

Based on the findings described above, in the apparatus according to the present mode (1), red-blood-cell image data representing an image of a red blood cell of a human being is produced for allowing a portion of a cross section of the red blood cell to be visualized as a ring-shaped figure, wherein the portion corresponds to a cell membrane of the red blood cell, and wherein the cross section is to be obtained by cutting the red blood cell in a direction in which the red blood cell is flat-shaped.

Therefore, this apparatus would allow classification of a red blood cell using the red-blood-cell image sharply which has been picked up of an outer and an inner surface of a cell membrane, and which therefore permits precise measurement of the thickness of the cell membrane.

Moreover, in this apparatus, based on the thus produced red-blood-cell image data, both an outer diameter of the ring-shaped figure corresponding to a diameter of the red blood cell, and a width of the ring-shaped figure corresponding to a thickness of the cell membrane of the red blood cell are extracted as features of the red blood cell.

Accordingly, this apparatus would make it possible to classify a red blood cell by considering both the diameter thereof and the thickness of the cell membrane, and therefore, this apparatus would allow, based on the findings of the present inventors described above by reference to the previously-mentioned micrographs, correct classification of a red blood cell for the use of determining the constitution of a human being.

Further, in this apparatus, based on the extracted features, a red blood cell is classified as one of a predetermined plurality of types of red blood cell types. The plurality of red blood cell types include, in accordance with the aforementioned findings of the present inventors: an expansion type where a red blood cell shows an expansion tendency; a contraction type where a red blood shows a contraction tendency; and a medium type which is situated between the expansion and the contraction type, as three basic types of red blood cells.

Therefore, this apparatus would allow classification of a red blood cell as one of a plurality of types of red blood cells, as a result of focus on both the diameter of the red blood cell and the thickness of a cell membrane of the red blood cell.

The “red-blood-cell image data” in the present mode (1) may be produced by, for example, picking up an image of blood which has been collected from the body of a human being, using a microscope, by picking up an image of blood which is flowing within the capillary in the close proximity of the skin, or the arteriole or the venule of a human being, using a microscope, etc.

The diameter of a red blood cell and the thickness of its cell membrane tend to retain the relationship therebetween that the larger the diameter of the red blood cell, the thinner the cell membrane. Therefore, it is thought that focusing attention only on either the diameter or the thickness would be adequate. However, it is considered that there arise both a case in which the classification of a red blood cell performed by focusing attention only on the diameter is inadequate, and a case in which the classification of a red blood cell made by focusing attention only on the thickness is inadequate.

By contrast, the apparatus according to the present mode (1) would allow classification of a red blood cell in light of both the diameter thereof and the thickness of its cell membrane, and therefore, this apparatus would make it easier to ensure the accuracy of classification of a red blood cell.

However, this apparatus may be practiced in an arrangement to additionally incorporate a function to classify a red blood cell by focusing only on the diameter thereof, in an arrangement to additionally incorporate a function to classify a red blood cell by focusing only on the thickness of its cell membrane.

(2) The apparatus according to mode (1), wherein the red-blood-cell classification means classifies the red blood cell as a selected one of the contraction, the medium, and the expansion type, such that the selected one changes in a description order of the contraction, the medium, and the expansion type with increase in the diameter, and such that the selected one changes in a description order of the expansion, the medium, and the contraction type with increase in the thickness.

(3) The apparatus according to mode (1) or (2), wherein the plurality of types of red blood cells further includes at least one combination type combining at least two of the three basic types.

As is evident from the above-described explanation of mode (1), when the classifications of pre-cultured red blood cells and those of post-cultured red blood cells are considered in combination, it is understood that types of red blood cells include: three basic types consisting of an expansion, a medium, and a contraction type; and at least one combination type which is a composition of at least two of the basic types.

Based on these findings, in the apparatus according to the present mode (3), the plurality types of red blood cells in the above mode (1) includes, in addition to three basic types of red blood cells, at least one combination type which is a composition of two of the three basic types of red blood cells.

Here, one example of the “combination type of red blood cell” is a type combining an expansion and a contraction type which both belong to the basic types of red blood cells. Another example is a type combining an expansion and a medium type which both belong to the basic types of red blood cells. Still another example is a type combining a contraction and a medium type which both belong to the basic types of red blood cells.

(4) The apparatus according to any one of modes (1) through (3), wherein the red-blood-cell image data includes at least one of first and second red-blood-cell image data, wherein the first red-blood-cell image data represents an image which is picked up, using a microscope, of a pre-cultured red-blood-cell, after the blood containing the red blood cell is collected from a body of the human being, and without culturing the red blood cell in the collected blood, and wherein the second red-blood-cell image data represents an image which is picked up, using a microscope, of a post-cultured red-blood-cell in the collected blood, after culturing the red blood cell.

By reference to the explanation on the above mode (1), it is possible to classify a red blood cell on the basis of an image of a pre-cultured red-blood-cell which is picked up, using amicroscope, after the blood containing the red blood cell is collected from a body of the human being, and without culturing the red blood cell in the collected blood. Further, it is also possible to classify a red blood cell on the basis of an image of a post-cultured red-blood-cell which is picked up, using a microscope, after culturing the red blood cell.

Based on these findings, in the apparatus according to the present mode (4), the red-blood-cell image data set forth in any one of modes (1) through (3) includes at least one of the first red-blood-cell image data representative of an image of the pre-cultured red-blood-cell, and the second red-blood-cell image data representative of an image of the post-cultured red-blood-cell.

(5) The apparatus according to any one of modes (1) through (4), wherein the plurality of types of red blood cells further includes at least one combination type of a red blood cell combining at least two of the three basic types;

wherein the red-blood-cell image data includes:

first red-blood-cell image data representing an image of a pre-cultured red blood cell, which is picked up using a microscope, after the blood is collected from a body of the human being, and without culturing the red blood cell in the collected blood; and

second red-blood-cell image data representing an image of a post-cultured red blood cell, which is picked up using a microscope, after culturing the red blood cell in the collected blood;

wherein the red-blood-cell classification means includes:

(a) a provisional classification portion for provisionally classifying the red blood cell as one of the three basic types, on the basis of the first red-blood-cell image data, and depending on the outer diameter and the width of the ring-shaped figure indicating the image of the pre-cultured red blood cell; and

(b) a final classification portion for finally classifying the red blood cell as the same one of the basic types as which the red blood cell has been provisionally classified, or one of the at least one combination type, on the premise of one of the basic types as which the red blood cell has been provisionally classified, on the basis of the second red-blood-cell image data, and depending on the outer diameter and the width of the ring-shaped figure indicating the image of the post-cultured red blood cell.

By reference to the explanation on the above mode (1), when a red blood cell is provisionally classified on the basis of the pre-cultured red-blood-cell image, and when the same red blood cell is finally classified based on the result of the provisional classification, the accuracy of classification of a red blood cell will be improved more easily than when a red blood cell is classified based only on the pre-cultured red-blood-cell image.

Based on these findings, in the apparatus according to the present mode (5), a red blood cell is provisionally classified as one of the three basic types of red blood cells, depending on an outer diameter and a width of the ring-shaped figure representative of the pre-cultured red-blood cell, namely, a diameter of a pre-cultured red-blood-cell and a thickness of its cell membrane. Then, the red blood cell is finally classified as the same one of the basic types as which the red blood cell has been provisionally classified, or one of the at least one combination type, on the premise of one of the basic types as which the red blood cell has been provisionally classified, and depending on an outer diameter and a width of the ring-shaped figure indicating the image of the post-cultured red blood cell, namely, a diameter of the post-cultured red-blood-cell and a thickness of its cell membrane.

(6) The apparatus according to any one of modes (1) through (5), wherein the feature extraction means includes a pattern-recognition means for effecting a pattern recognition for the image of the red blood cell, thereby to extract the diameter of the image of the red blood cell and the thickness of the cell membrane as the features.

This apparatus would allow, by employing a pattern-recognition technique for images, extraction of a diameter of a red blood cell and a thickness of its cell membrane as features of the red blood cell.

(7) The apparatus according to mode (6), wherein the pattern-recognition means makes, with the image of the red blood cell being handled as an input pattern, and with a presupposed plurality of types of images of red blood cells being handled as a plurality of standard patterns, respectively, a match between the input pattern and the plurality of standard patterns, thereby to select one of the plurality of standard patterns which is the most similar to the input pattern as a similar standard-pattern, whereby the diameter of the red blood cell and the thickness of the cell membrane are extracted as the features.

(8) The apparatus according to any one of modes (1) through (7), wherein the image of the red blood cell represents the blood of the human being before food intake.

The shape of a red blood cell of a human being whose blood is collected changes between before and after food intake by the human being. Meanwhile, it is more suitable for an improved accuracy, to identify the true shape of the red blood cell of the same human being by the blood collected before food intake, than to identify it by the blood collected after food intake.

Depending on these findings, in the apparatus in accordance with the present mode (8), the image of the red blood cell set forth in any one of modes (1) through (7) is defined to represent the blood of a human being before food intake.

(9) The apparatus according to any one of modes (1) through (8), wherein the plurality of constitutions comprises a yin-nature, a yang-nature, and a medium-nature as three basic types of constitutions, and wherein the constitution determination means determines the constitution as the yin-nature, the yang-nature, or the medium-nature, when the red blood cell has been classified as the expansion type, the contraction type, or the medium type, respectively.

(10) The apparatus according to mode (9), wherein the plurality of types of red blood cells further comprises at least one combination type of a red blood cell combining two of the three basic types of red blood cells, wherein the plurality of types of constitutions further comprises at least one combination type of constitution combining two of the three basic types of constitutions, and wherein the constitution determination means determines the constitution as one of the at least one combination type of constitution, when one of the types of red blood cells as which the red blood cell has been classified corresponds to one of the at least one combination type of red blood cell.

(11) The apparatus according to any one of modes (1) through (10), further comprising:

a proper-diet-plan memory in which a predetermined plurality of kinds of proper-diet-plans have been stored directly or indirectly associated with the predetermined plurality of types of red blood cells, respectively; and

a proper-diet-plan displaying means for retrieving, in the proper-diet-plan memory, a proper-diet-plan corresponding to one of the types of red blood cells as which the red blood cell has been classified, and for displaying a content of the retrieved proper-diet-plan on a screen of the computer.

As described in the above mode (1), a constitution of a human being, which is to say, the physical features (physiological or pathological features) of a human being, and the shape of a red blood cell of the human being are deeply involved in each other. On the other hand, it has been said that factors determining the constitution of a human being include an acquired factor as well as a congenital factor. The acquired factor includes foods that human beings take.

Therefore, when the actual constitution of a human being is deviated from an ideal one (i.e., a medium one), it is possible to idealize the actual constitution of the human being (i.e., to make it closer to the medium one) by improving the diet that the human being has.

Based on these findings, in the apparatus in accordance with the present mode (11), depending on one of the types of red blood cells which has been specified through classification performed based on the diameter of a red blood cell of a human being and the thickness of the cell membrane, a plan of a diet which is recommended as one that the human being should have is provided as a proper-diet-plan. To be more specific, in a proper-diet-plan memory in which a predetermined plurality of kinds of proper-diet-plans have been stored directly or indirectly associated with a predetermined plurality of types of red blood cells, respectively, there is retrieved a proper-diet-plan corresponding to one of the types of red blood cells as which the red blood cell has been classified, and the content of the retrieved proper-diet-plan is displayed on a screen.

The “proper-diet-plan” in the present mode (11) may be interpreted to include a proper plan for a human being's act to take general foods (including what is called health foods), may be interpreted to include a proper plan for a human being to take all kinds of substances including foods with health claims that foods with nutrient function claims and foods for specified health use belong to, supplements, etc.

The apparatus according to the present mode (11) may be constructed such that the proper-diet-plan memory has stored therein the relationship between a predetermined plurality of kinds of proper-diet-plans and a predetermined plurality of types of constitutions. Further, the apparatus according to the present mode (11) may be also constructed such that the proper-diet-plan memory has stored therein the relationship between a predetermined plurality of kinds of proper-diet-plans and a predetermined plurality of types of red blood cells.

(12) The apparatus according to mode (11), wherein the proper-diet-plan displaying means displays, on the screen, the proper-diet-plan in the form of a recipe of a diet recommended as one that the human being should have.

The apparatus according to the above mode (11) may be practiced in such an arrangement that the proper-diet-plan is displayed on the screen in the form of materials of a diet recommended as one that the human being should have. However, in this arrangement, when the human being has the recommended diet, the human being himself or herself or a party concerned has to choose appropriate ones from the displayed materials and cook or prepare the diet, which is troublesome.

Alternatively, in the apparatus according to the present mode (12), the proper-diet-plan is displayed on the screen in the form of a recipe of a diet recommended as one that the human being should have. Therefore, this apparatus would reduce a need of the human being himself or herself or a party concerned to choose materials for preparing the recommended diet, resulting in an easy reduction in time and labor.

(13) The apparatus according to mode (12), wherein the proper-diet-plan displaying means includes a first means for displaying the recipe of the diet such that the recipe is segmented into a staple food, a side dish, and drinkables or liquid foods.

(14) The apparatus according to mode (13), wherein the first means displays: a plurality of kinds of candidate foods which is recommended for the human being to take as staple foods; a plurality of kinds of candidate foods which is recommended for the human being to take as side dishes; and a plurality of kinds of drinkables and liquid foods which is recommended for the human being to take as drinkables and liquid foods.

(15) The apparatus according to any one of modes (12) through (14), wherein the proper-diet-plan displaying means comprises a second means for displaying the recipe of the diet, per each meal or per each set of means for each day, in the form of eatables and drinkables recommended for the human being to take.

(16) A program executed by a computer to implement a method for determining a constitution of a human being, the method comprising:

a feature extraction step of extracting an outer diameter of a ring-shaped figure corresponding to a diameter of the red blood cell, and a width of the ring-shaped figure corresponding to a thickness of a cell membrane of the red blood cell, as features of a red blood cell in blood of the human being, on the basis of red-blood-cell image data representing a two-dimensional image of the red blood cell which is flat-shaped on a plane and which is enclosed by the cell membrane having the thickness, wherein the red-blood-cell image data is produced for allowing a portion of a cross section of the red blood cell to be obtained by cutting the red blood cell in a direction of the plane, to be visualized as the ring-shaped figure, wherein the portion corresponds to the cell membrane;

a red-blood-cell classification step of classifying the red blood cell as one of a predetermined plurality of types of red blood cells, on the basis of the extracted features, wherein the plurality of types includes an expansion type where a red blood cell exhibits an expansion tendency, a contraction type where a red blood cell exhibits a contraction tendency, and a medium type which is intermediate between the expansion and the contraction type, as three basic types of red blood cells; and

a constitution determination step of determining the constitution of the human being as one of a predetermined plurality of types of constitutions of human beings, on the basis of one of the plurality of types of red blood cells as which the red blood cell has been classified.

Execution of this program by a computer would allow provision of the same functions and effects as the apparatus according to the above mode (1).

The “method for determining a constitution of a human being” may be practiced in such an arrangement as to employ the features as set forth in any one of modes (2) through (15).

The “program” in the present mode (16) may be interpreted to incorporate not only a combination of instructions implemented by a computer to perform the functions of the program, but also files, data, etc. processed depending on each of the instructions.

(17) A recording medium which has stored therein the program according to mode (16) in a computer-readable manner.

Execution of the program stored in this recording medium would allow provision of the same functions and effects as the apparatus according to the above mode (1).

The “recording medium” in the present mode (17) may accept various kinds of formats, for example, at least any one of a magnetic recording medium such as a flexible disc; an optical recording medium such as a CD, and a CD-ROM; an magnetic optical recording medium such as an MO; an un-removable storage such as a ROM; etc.

(18) An apparatus for processing red-blood-cell image data representing a two-dimensional image of a red blood cell in blood of a human being, wherein the red blood cell is flat-shaped on a plane and is enclosed by a cell membrane having a thickness, and wherein the red-blood-cell image data is produced for allowing a portion of a cross section of the red blood cell to be obtained by cutting the red blood cell in a direction of the plane, to be visualized as a ring-shaped figure, wherein the portion corresponds to the cell membrane, the apparatus comprising:

a feature extraction means for extracting an outer diameter of the ring-shaped figure corresponding to a diameter of the red blood cell, and a width of the ring-shaped figure corresponding to the thickness of the cell membrane of the red blood cell, as features of the red blood cell, on the basis of the red-blood-cell image data; and

a red-blood-cell classification means for classifying the red blood cell as one of a predetermined plurality of types of red blood cells, on the basis of the extracted features, wherein the plurality of types includes an expansion type where a red blood cell exhibits an expansion tendency, a contraction type where a red blood cell exhibits a contraction tendency, and a medium type which is intermediate between the expansion and the contraction type, as three basic types of red blood cells.

The apparatus according to the above mode (1) may be recognized such that the apparatus is separated into a portion of classifying a red blood cell, and a portion of determining a constitution of a human being, and it is the apparatus according to the present mode (18) that is constructed by focusing only on the portion of classifying a red blood cell.

Therefore, this apparatus according to the present mode (18) would permit provision of a corresponding part of the functions and effects to be provided by the apparatus according to the above mode (1).

(19) The apparatus according to mode (18), further comprising a constitution determination means for determining the constitution of the human being as one of a predetermined plurality of types of constitutions, wherein the plurality of types of constitutions includes a yin-nature, a yang-nature, and a medium-nature as three basic types of constitutions, and wherein the constitution determination means determines the constitution as the yin-nature, the yang-nature, or the medium-nature, when the red blood cell has been classified as the expansion type, the contraction type, or the medium type, respectively.

(20) A program executed by a computer to implement a method for processing red-blood-cell image data representing a two-dimensional image of a red blood cell in blood of a human being, wherein the red blood cell is flat-shaped on a plane and is enclosed by a cell membrane having a thickness, and wherein the red-blood-cell image data is produced for allowing a portion of a cross section of the red blood cell to be obtained by cutting the red blood cell in a direction of the plane, to be visualized as a ring-shaped figure, wherein the portion corresponds to the cell membrane, the method comprising:

a feature extraction step of extracting an outer diameter of the ring-shaped figure corresponding to a diameter of the red blood cell, and a width of the ring-shaped figure corresponding to the thickness of the cell membrane of the red blood cell, as features of the red blood cell, on the basis of the red-blood-cell image data; and

a red-blood-cell classification step of classifying the red blood cell as one of a predetermined plurality of types of red blood cells, on the basis of the extracted features, wherein the plurality of types includes an expansion type where a red blood cell exhibits an expansion tendency, a contraction type where a red blood cell exhibits a contraction tendency, and a medium type which is intermediate between the expansion and the contraction type, as three basic types of red blood cells.

### BRIEF DESCRIPTION OF THE SEVERAL VIEWS OF THE DRAWINGS

In the drawings:

FIG. 1 schematically illustrates a proper-diet-plan presentation system according to a first embodiment of the present invention;

FIG. 2 is a block diagram schematically illustrating several kinds of devices to be connected to an image capturing device 60 in FIG. 1;

FIG. 3 is a flow chart schematically illustrating a main program which has been stored in a program memory 36 in FIG. 1;

FIG. 4 is a flow chart schematically illustrating a program for processing image data of red blood cells, which has been stored in the program memory 36 in FIG. 1;

FIG. 5 is a flow chart schematically illustrating S23 in FIG. 4 by the name of feature extraction routine, in more detail;

FIG. 6 is a front view illustrating features referring to a diameter of an image of a red blood cell and a thickness of a cell membrane in the feature extraction routine in FIG. 5;

FIG. 7 is a front view illustrating variations in the diameter d of the image of the red blood cell in the feature extraction routine in FIG. 5;

FIG. 8 is a front view illustrating variations in the thickness t of the image of the red blood cell in the feature extraction routine in FIG. 5;

FIG. 9 illustrates in a table a relationship represented by data of pre-culture relationship between features and types of red blood cells, wherein the data has been stored in a data memory 38 in FIG. 1;

FIG. 10 illustrates in a table a relationship represented by data of post-culture relationship between features and types of red blood cells, wherein the data has been stored in the data memory 38 in FIG. 1;

FIG. 11 illustrates in a table the fact that a part of a plurality of final types of red blood cells in FIG. 10 is constructed by combining a plurality of basic types of red blood cells;

FIG. 12 is a flow chart schematically illustrating a constitution determination program which has been stored in the program memory 36 in FIG. 1;

FIG. 13 illustrates in a table a relationship represented by data of a relationship between types of red blood cells and types of constitutions, wherein the data has been stored in the data memory 38 in FIG. 1;

FIG. 14 is a flow chart schematically illustrating a proper-diet-plan presentation program which has been stored in the program memory 36 in FIG. 1;

FIG. 15 is a front view illustrating an example of an image displayed on a screen as a result of execution of the proper-diet-plan presentation program in FIG. 14;

FIG. 16 is a micrograph of a pre-cultured blood in which a red blood cell shows an expansion type;

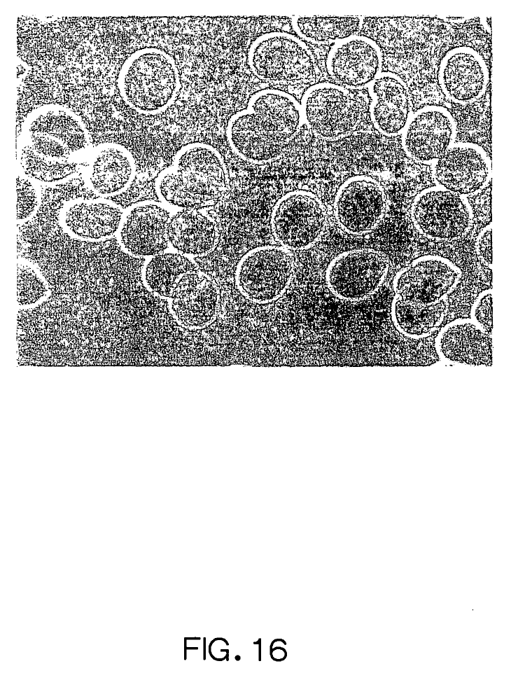

FIG. 17 is a micrograph of a post-cultured blood in which a red blood cell shows a strong-expansion type;

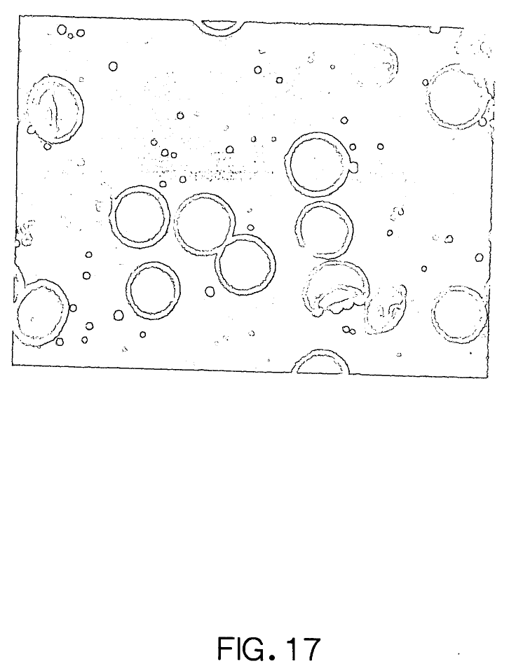

FIG. 18 is a micrograph of a post-cultured blood in which a red blood cell shows a normal-expansion type;

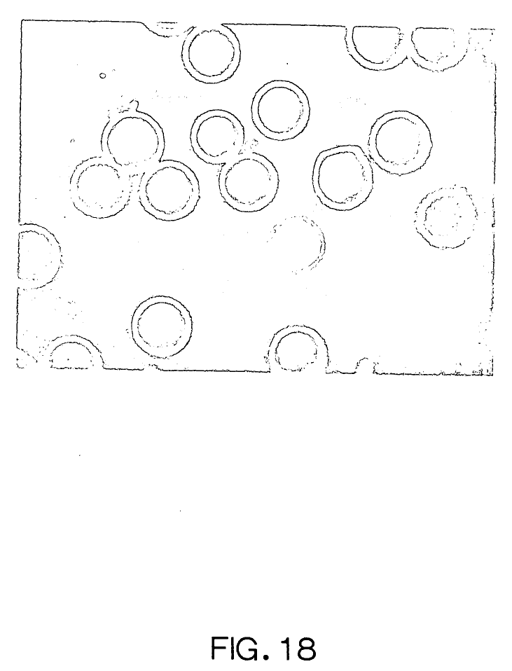

FIG. 19 is a macrograph of a post-cultured blood in which a red blood cell shows an expansion type with a contraction tendency;

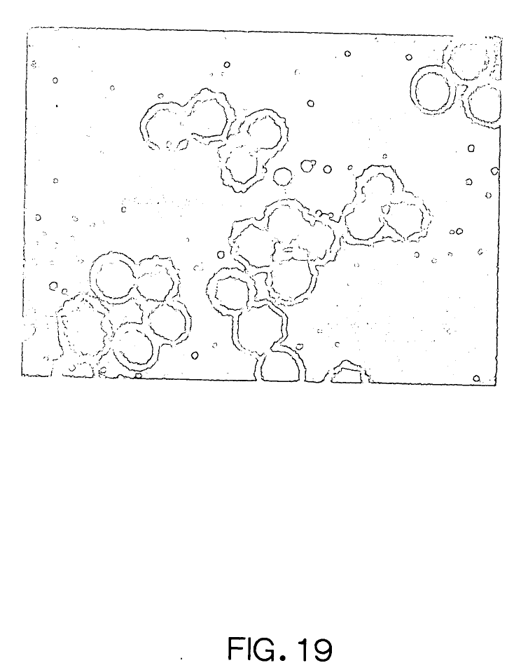

FIG. 20 is a micrograph of a pre-cultured blood in which a red blood cell shows a medium type;

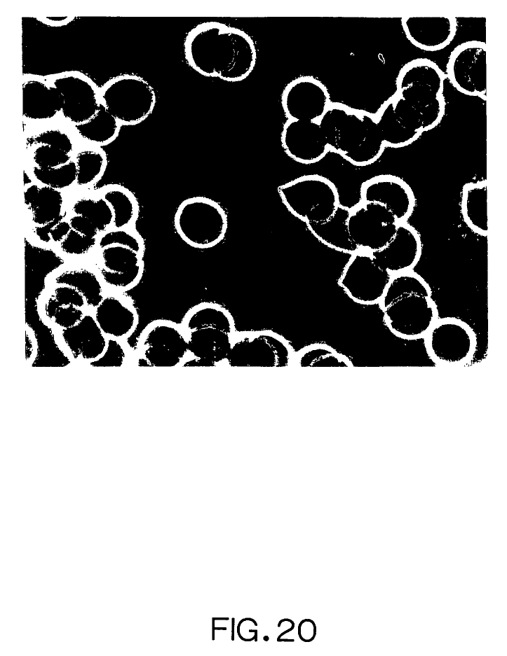

FIG. 21 is a micrograph of a post-cultured blood in which a red blood cell shows a medium type with an expansion tendency;

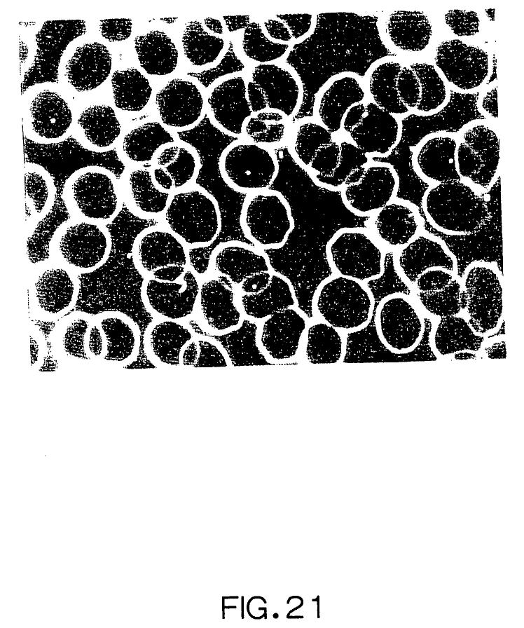

FIG. 22 is a micrograph of a post-cultured blood in which a red blood cell shows a normal-medium type;

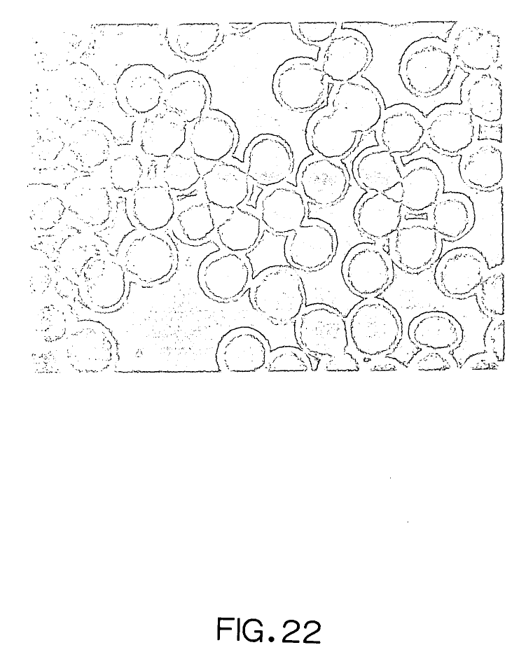

FIG. 23 is a micrograph of a post-cultured blood in which a red blood cell shows a medium type with a contraction tendency;

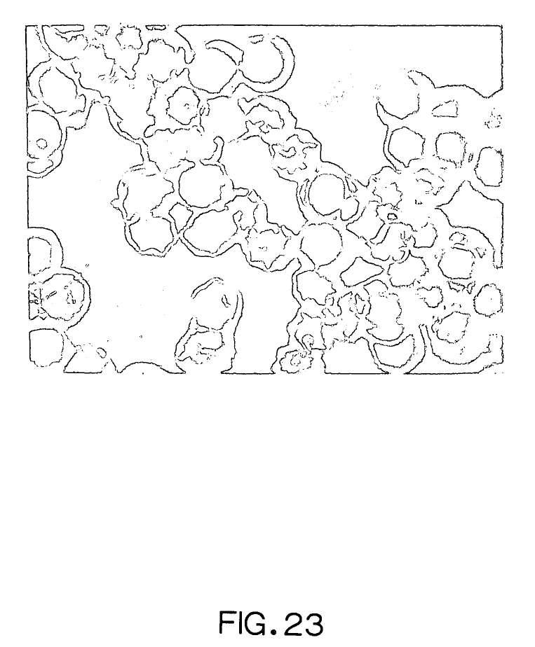

FIG. 24 is a micrograph of a pre-cultured blood in which a red blood cell shows a contraction type;

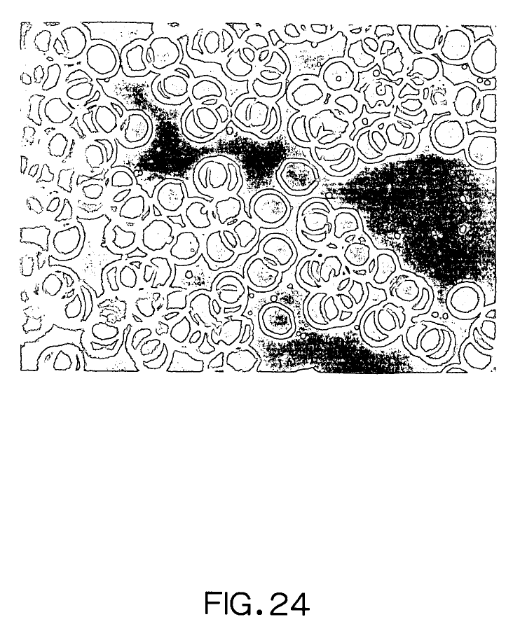

FIG. 25 is a micrograph of a post-cultured blood in which a red blood cell shows a strong-contraction type;

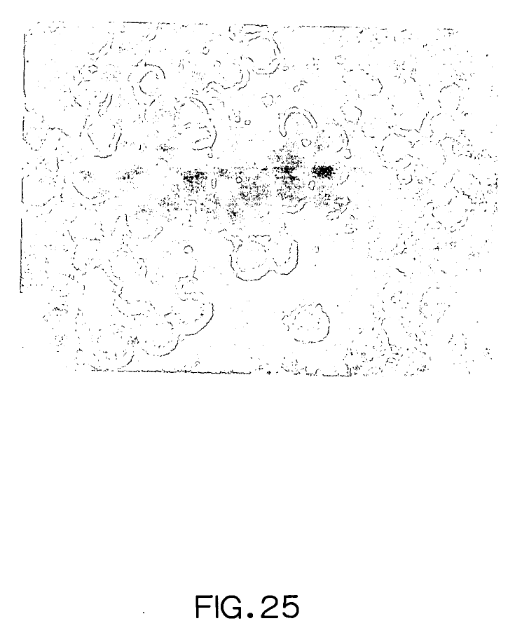

FIG. 26 is a micrograph of a post-cultured blood in which a red blood cell shows a normal-contraction type;

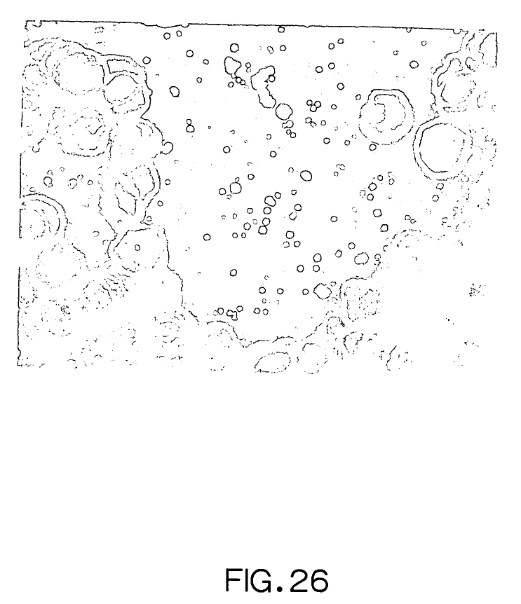

FIG. 27 is a micrograph of a post-cultured blood in which a red blood cell shows a contraction type with an expansion tendency;

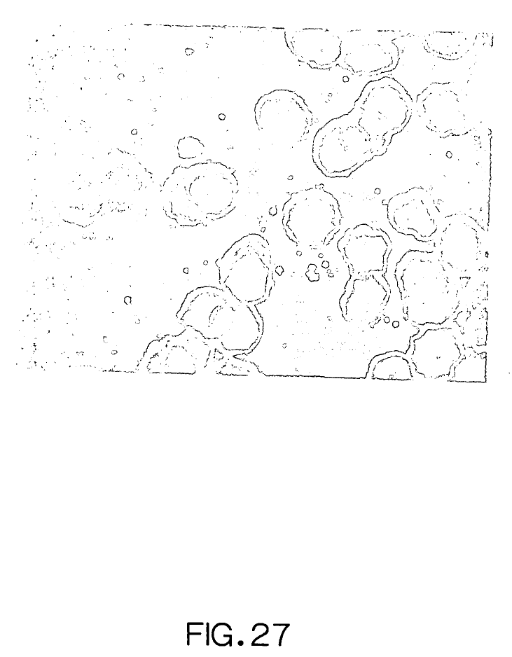

FIG. 28 is a diagram for explaining in a table a relationship obtained experimentally between determination results of constitutions and determination results of red blood cells;

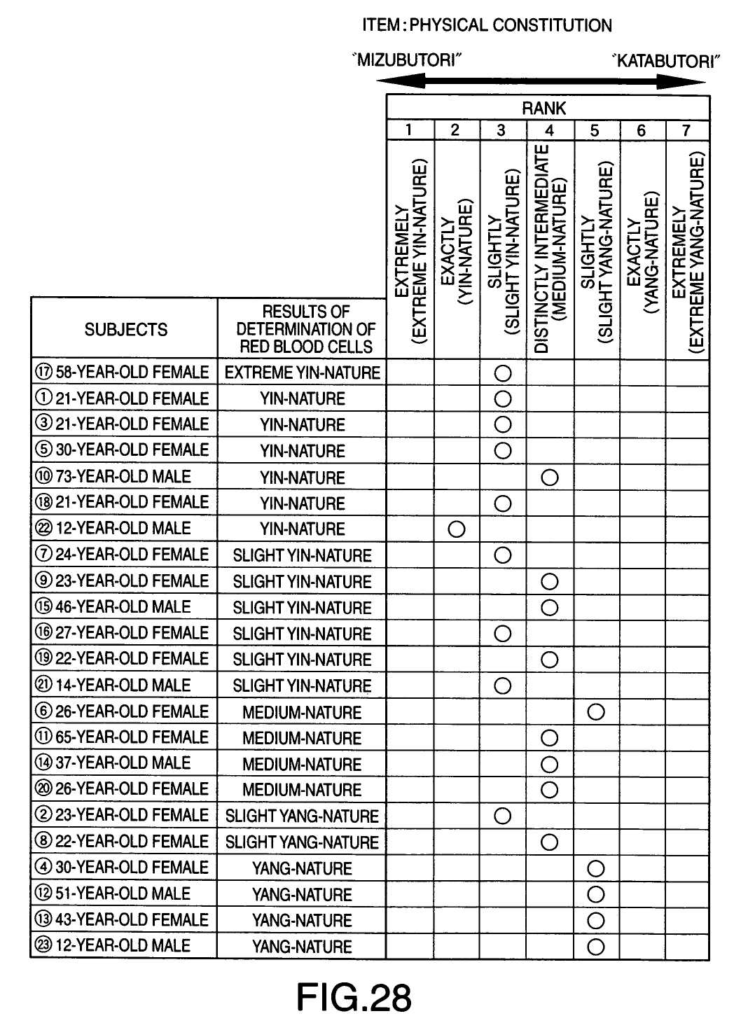

FIG. 29 is another diagram for explaining in a table a relationship obtained experimentally between determination results of constitutions and determination results of red blood cells;

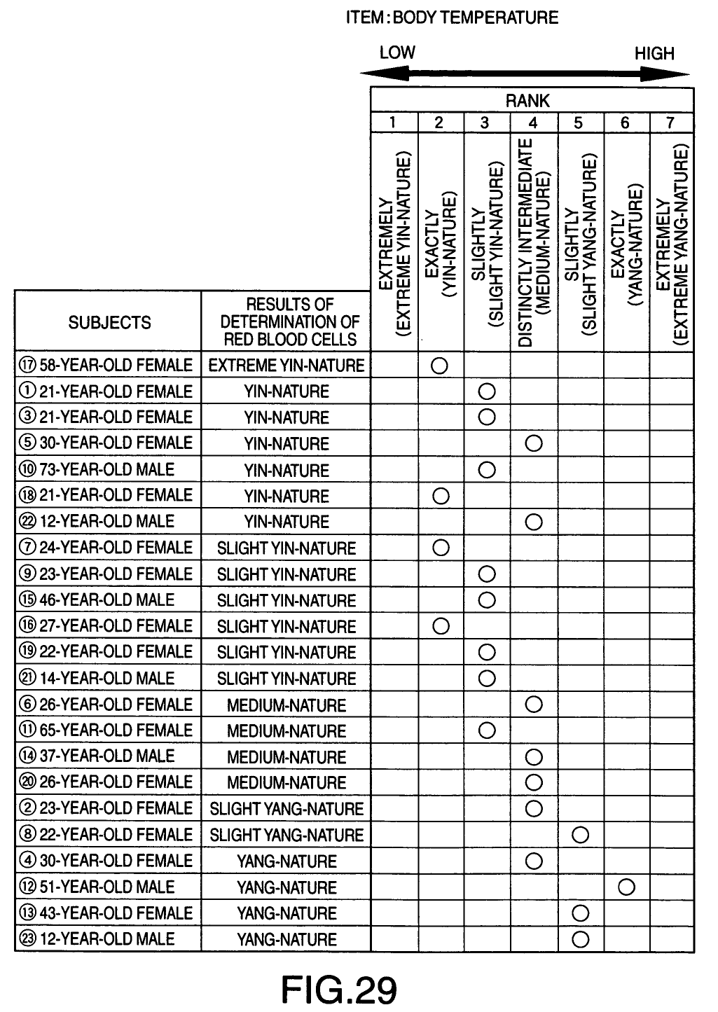

FIG. 30 is still another diagram for explaining in a table a relationship obtained experimentally between determination results of constitutions and determination results of red blood cells.

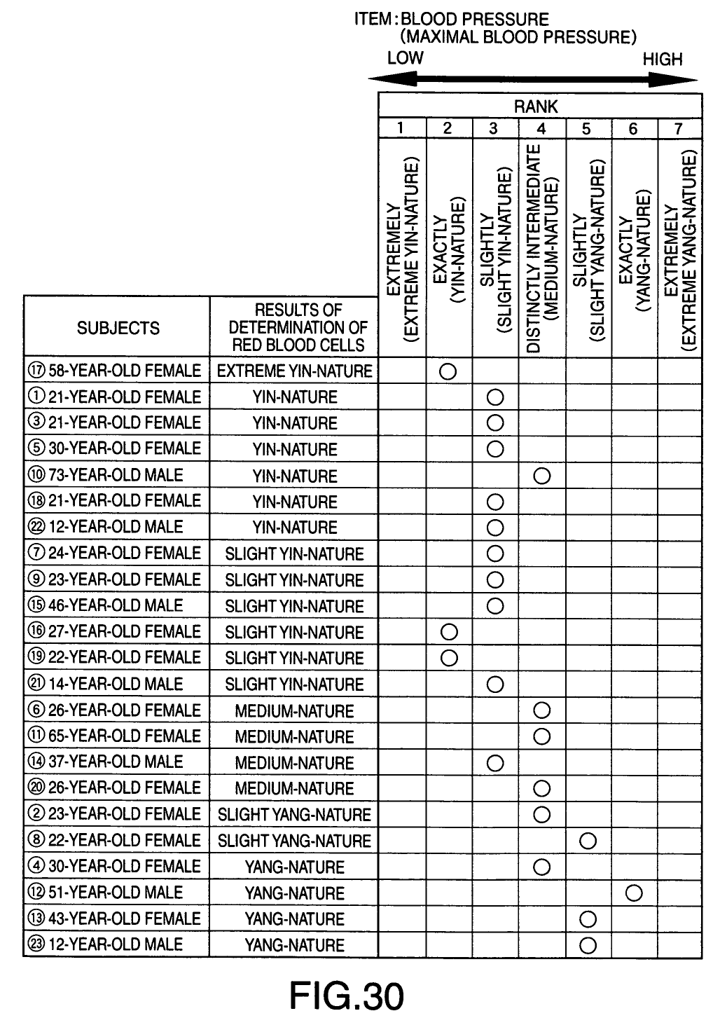

### DETAILED DESCRIPTION OF THE INVENTION

There will be described below a more specific one of embodiments according to the present invention in more detail by reference to the drawings.

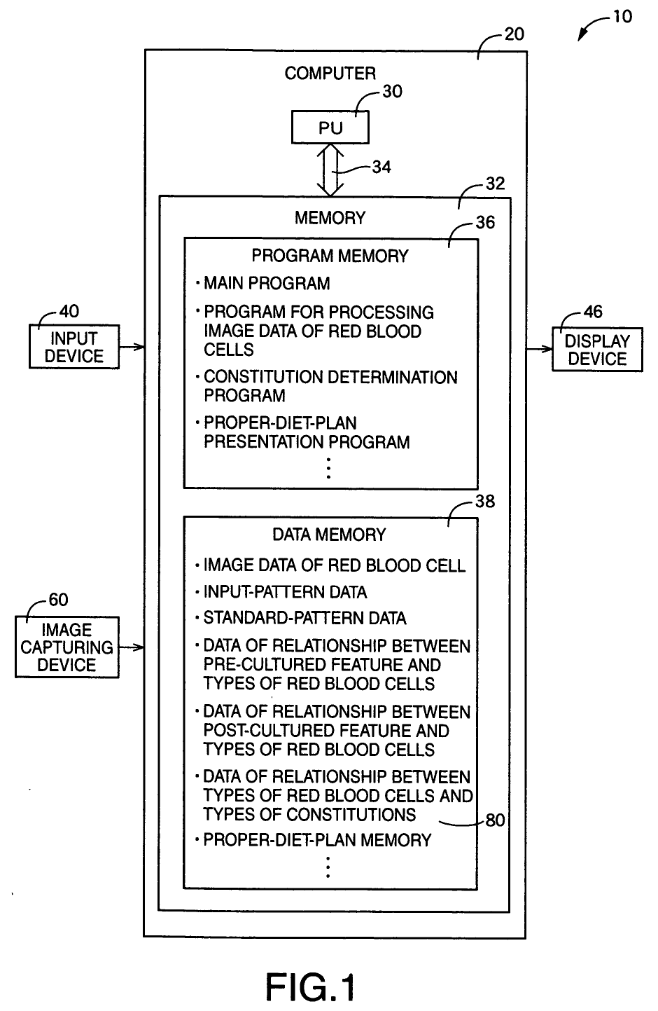

In FIG. 1, a hardware resource of a proper-diet-plan presentation system (hereinafter, referred to simply as “system”) according to one embodiment of one aspect of the present invention is schematically shown in a block diagram. The system includes; an apparatus for determining a human's constitution according to one embodiment of another aspect of the present invention; and a recording medium according to one embodiment of yet another aspect of the present invention.

The system is used by a plurality of users, each of who requests the system to provide a proper-diet-plan presentation service to the users. The system may be embodied using a combination of a personal computer personally used at home, and a server computer connected to the personal computer via the Internet functioning as a communication network, or may be embodied using a personal computer, without relying on a server computer.

As shown in FIG. 1, the system 10 is constructed to primarily have a computer 20. The computer 20 is constructed such that a processing unit (hereinafter, abbreviated as “PU”) 30 and a memory 32 are connected with each other via a bus 34.

The memory 32 is constructed to include recording medium, such as a ROM, a RAM, a magnetic disk, an optical disk, etc. In the memory 32, a program memory 36 in which various programs have been stored, and a data memory 38 in which various sets of data have been stored or will be stored, where necessary.

With the system 10, an input device 40 for inputting data to the system 10, and a display device 46 for displaying data output from the system 10 on a screen (not shown), are connected. One example of the input device 40 is constructed to have a keyboard, a mouse functioning as a pointing device, etc. On the other hand, one example of the display device 46 is constructed to have at least one of an LCD, a CRT, etc.

The system 10 is further equipped with an image capturing device 60. The image capturing device 60 is configured to capture an image of blood collected from the body of each user, in the form of a grayed image or variable density image (a multi-valued image within which concentration information of each picture element is multi-valued). While the present invention may be practiced in such an alternative embodiment that an image of a red blood cell is captured into the system 10 as a binary image, the concentration information of which is binarized, the present invention is practiced in the present embodiment, for the purpose of classifying a red blood cell by additionally considering levels of concentration of a cell membrane of a red blood cell within am image of the red blood cell, such that the image of the red blood cell is incorporated into the system 10 in the form of a multi-valued image.

The collection of blood from each user is preferably conducted before the each user's meal (for example, before breakfast).

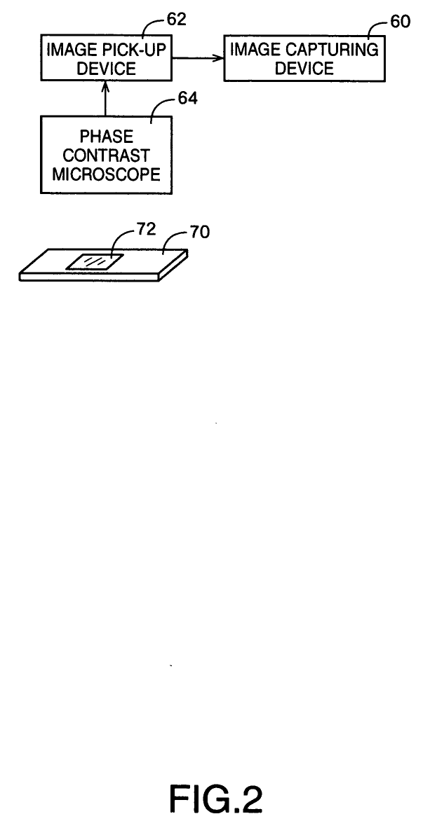

As shown in FIG. 2, the image capturing device 60 is connected to an image pick-up device 62 such as a CCD camera. The image pick-up device 62 is mounted with a phase contrast microscope 64 functioning as a microscope.

The phase contrast microscope 64 is used for observing blood collected from each user's body at a given magnification. In the present embodiment, for the blood collected from the same user, both a micrograph of the blood immediately after the blood is collected from the user, and a micrograph of the cultured blood are picked up.

To be more specific, initially, blood (whole blood) is collected from the fingertip of a user's body. The collected blood is put on a slide glass 70 as soon as possible, and then, the collected blood is covered with a cover glass 72, and the periphery of the cover glass 72 is sealed with oil for a microscope to perform an oil immersion, As a result, the collected blood is put under an anaerobic condition where the collected blood is isolated from oxygen.

The thus prepared blood sample is attached at a given position of the phase contrast microscope 64, and as a result, an image of a pre-cultured red blood cell is picked up.

After being picked up, the same blood sample is cultured. More particularly, the blood sample is stored within an incubator at a temperature of 38 degrees centigrade for a predetermined period of time (e.g., three days, several days, one week, and two weeks).

Upon culturing, in the same manner as when an image of a pre-cultured blood cell is picked up, an image of the blood sample is again picked up with the blood sample being attached to the phase contrast microscope 64, resulting in a picked-up image of a post-cultured red blood cell.

These images of the pre-cultured and the post-cultured red blood cell are both incorporated into the system 10 via the image capturing device 60.

As shown in FIG. 1, the program memory 36 has stored therein various kinds of programs, originally including a main program, a program for processing image data of red blood cells, a constitution determination program, and a proper-diet-plan presentation program.

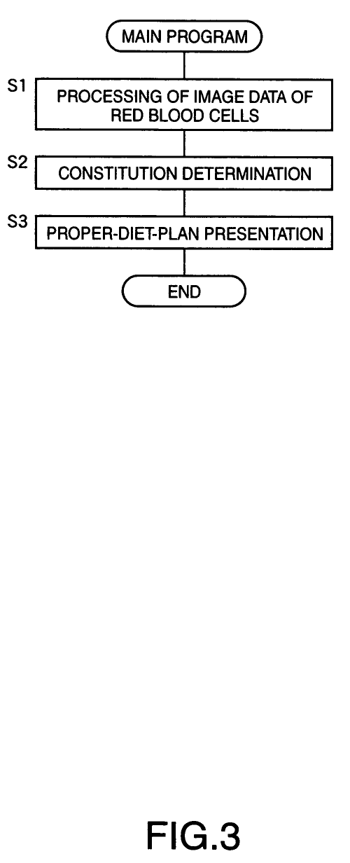

In FIG. 3, the main program is schematically illustrated in a flow chart. The main program is executed once for each user.

When each cycle of execution of this main program is initiated, in a step S1 (hereinafter, referred to simply as “S1.” The same is true for all other steps.), the program for processing image data of red blood cells is implemented. Thereafter, in S2, the constitution determination program is implemented. Following that, in S3, the proper-diet-plan presentation program is implemented. Then, one cycle of execution of this main program is terminated.

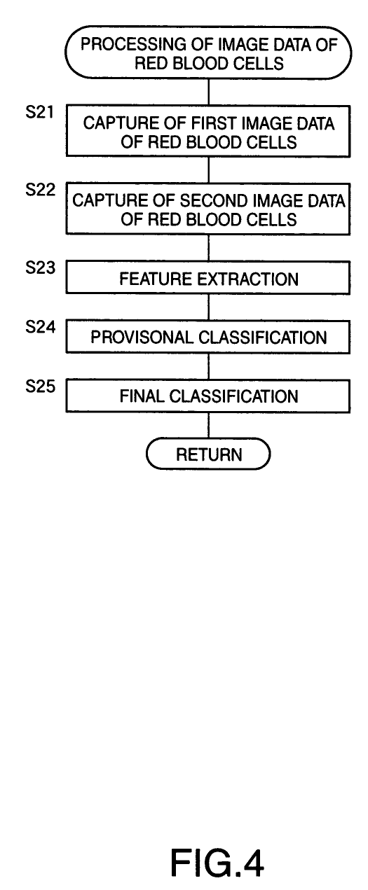

In FIG. 4, the program for processing image data of red blood cells is schematically illustrated in a flow chart.

For this program for processing image data of red blood cells, first of all, in S21, data representing the image of the pre-cultured red blood cell is captured into the computer 20, as a first red-blood-cell image data. The captured first red-blood-cell image data is stored into the data memory 38, as shown in FIG. 1.

Then, in S22, like in S21, data representing the image of the post-cultured red blood cell is captured into the computer 20, as a second red-blood-cell image data. Similarly, the captured second red-blood-cell image data is stored into the data memory 38, as shown in FIG. 1.

Following that, in S23, on the basis of the captured first and second red-blood-cell image data, features of the red blood cell are extracted for each of the images of the pre-cultured and the post-cultured red-blood-cell.

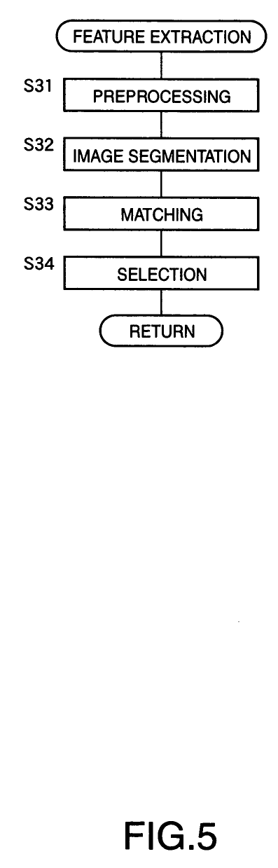

In FIG. 5, the details of S23 are schematically illustrated as the feature extraction routine in a flow chart.

For this feature extraction routine, first of all, in S31, the images of the pre-cultured and the post-cultured red blood cell are sequentially selected as a subject image, and along with that, for the subject image, preprocessing required for image processing such as later image segmentation is performed. The preprocessing may be performed such that edge enforcement process is implemented for separating a red-blood-cell image defined as each sub-image of and within the subject image, from the background of the subject image.

Following that, in S32, the image segmentation for the subject image is performed for segmenting the subject image into individual red-blood-cell images. For example, one subject image generates a plurality of red-blood-cell images as a result of the image segmentation.

After that, in S33, data representing each of the resulted red-blood-cell images is stored as an input-pattern data, as shown in FIG. 1, into the data memory 38. This data memory 38 has stored therein a plurality of sets of standard-pattern data respectively indicating a plurality of standard patterns with which an input pattern represented by the input-pattern data is to be matched.

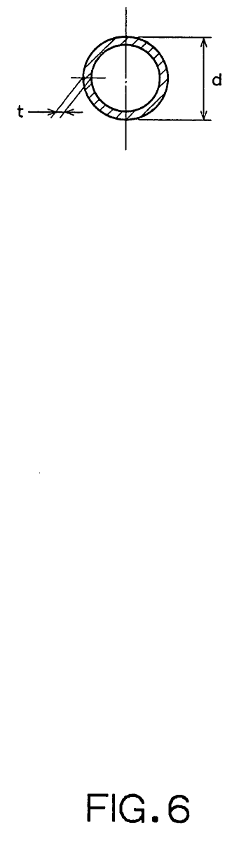

As shown in FIG. 6, an input pattern referring to a red-blood-cell image may be defined as a hollow or solid circle identified by the diameter d and the thickness t of the cell membrane.

Then, each of the standard patterns is defined as an image which is changed with parameters respectively referring to the diameter d and the thickness t, and the standard patterns are presupposed by variations in each parameter.

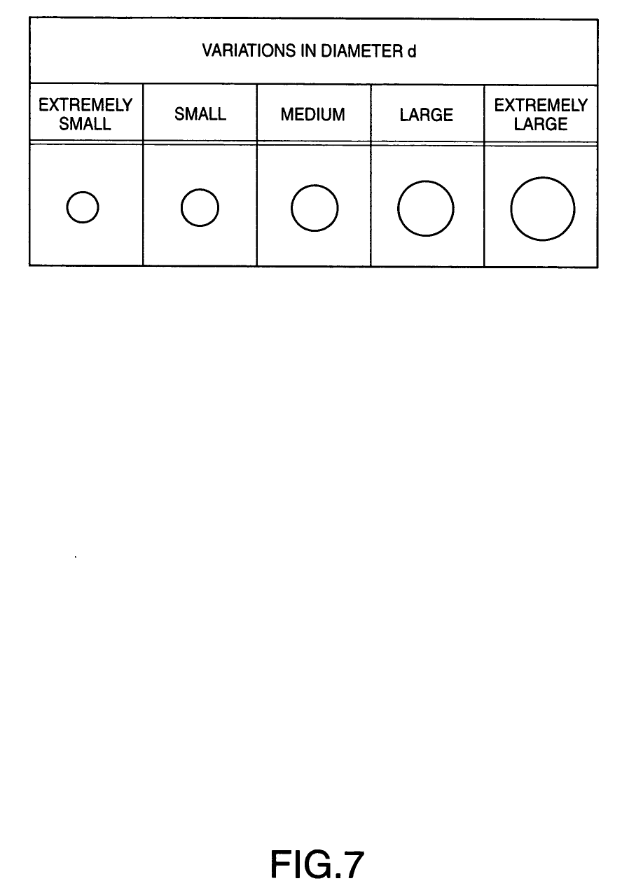

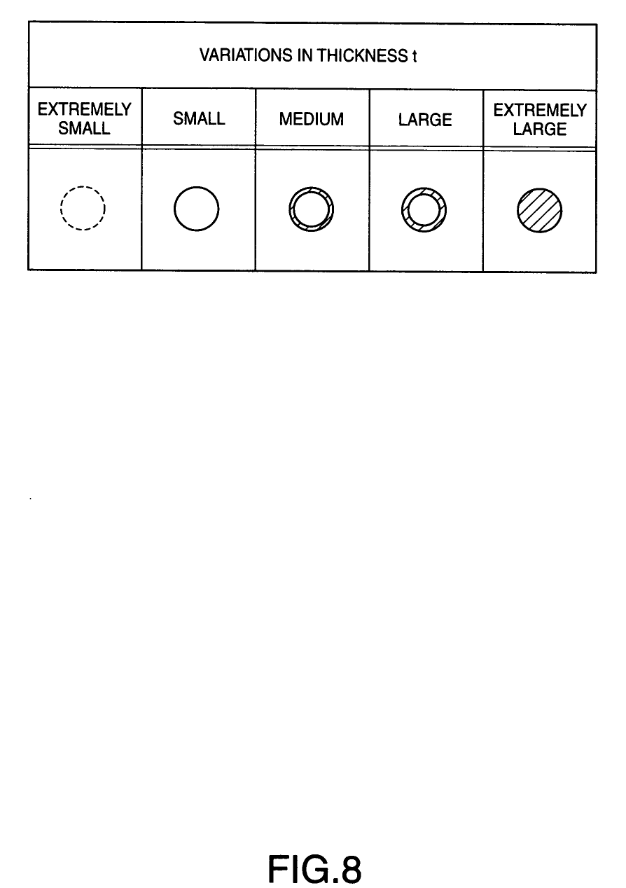

For the diameter d of the standard patterns, as shown in FIG. 7, five ranks respectively corresponding to “extremely small,” “small,” “medium,” “large,” and “extremely large” are provided. Alternatively, for the thickness t of the standard patterns, as shown in FIG. 8, five ranks respectively corresponding to “extremely small,” “small,” “medium,” “large,” and “extremely large” are provided, similarly.

When the thickness t of the input pattern is “extremely small”, the cell membrane of the input pattern is lighter or lower in concentration. Therefore, it is previously designed that, the standard pattern that rank “extremely small” has been assigned to is selected, on the condition that the cell membrane of the input pattern is lighter or lower in concentration, which is depicted in FIG. 8 in a broken line for the sake of convenience in explanation.

Alternatively, when the thickness t of the input pattern is “extremely large,” the cell membrane of the input pattern is darker or higher in concentration. As a result, it is previously designed that, the standard pattern that rank “extremely large” has been assigned to is selected, on the condition that the input pattern is entirely darker higher in concentration, which is depicted in FIG. 8 in a solid circle for the sake of convenience in explanation.

In S33 of FIG. 5, further, the plurality of standard patterns is sequentially read out from the data memory 38, and the read-out standard pattern is matched or collated with the current input pattern. Per each matching, the level of similarity (correlation) between the current standard pattern and the current input pattern is determined.

After that, in S34, based on the determined level of similarity, one of the plurality of standard patterns which is the most similar to the current input pattern with regard to the diameter d, and one of the plurality of standard patterns which is the most similar to the current input pattern with regard to the thickness t are selected. As a result of this selection, the diameter d of the red blood cell and the thickness t of the cell membrane are extracted as the features of the red blood cell from the current input pattern.

Then, one cycle of execution of this feature extraction routine is terminated.

Thereafter, in S24 of FIG. 4, based on the image of the pre-cultured red blood cell, a provisional classification (sorting) of the red blood cell of the current user is performed.

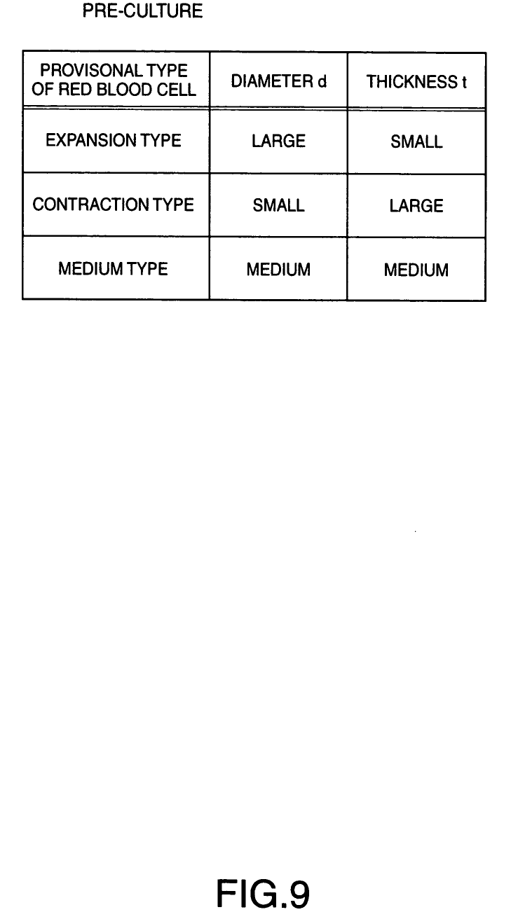

As shown in FIG. 1, data of a pre-cultured relationship between features and types of red blood cells has been stored in the data memory 38. In FIG. 9, the relationship represented by the data of the pre-cultured relationship is shown in a table.

According to the relationship represented by the data of the pre-cultured relationship between features and types of red blood cells, an expansion type is selected as a provisional type of the red blood cell, on the condition that the rank of the diameter d of the red blood cell is “large,” and that the rank of the thickness t is “small.” In addition, a contraction type is selected as a provisional type of the red blood cell, on the condition that the rank of the diameter d is “small,” and that the rank of the thickness t is “large.” Additionally, a medium type is selected as a provisional type of the red blood cell, on the condition that the rank of the diameter d is “medium,” and that the rank of the thickness t is also “medium.”

Then, in S24 of FIG. 4, according to the relationship represented by the data of the pre-cultured relationship between features and types of red blood cells, the current provisional type of the red blood cell is classified as one of the expansion, the contraction, and the medium type.

Following that, in S25, on the basis of the image of the post-cultured red blood cell, a final classification of the red blood cell of the current user is performed.

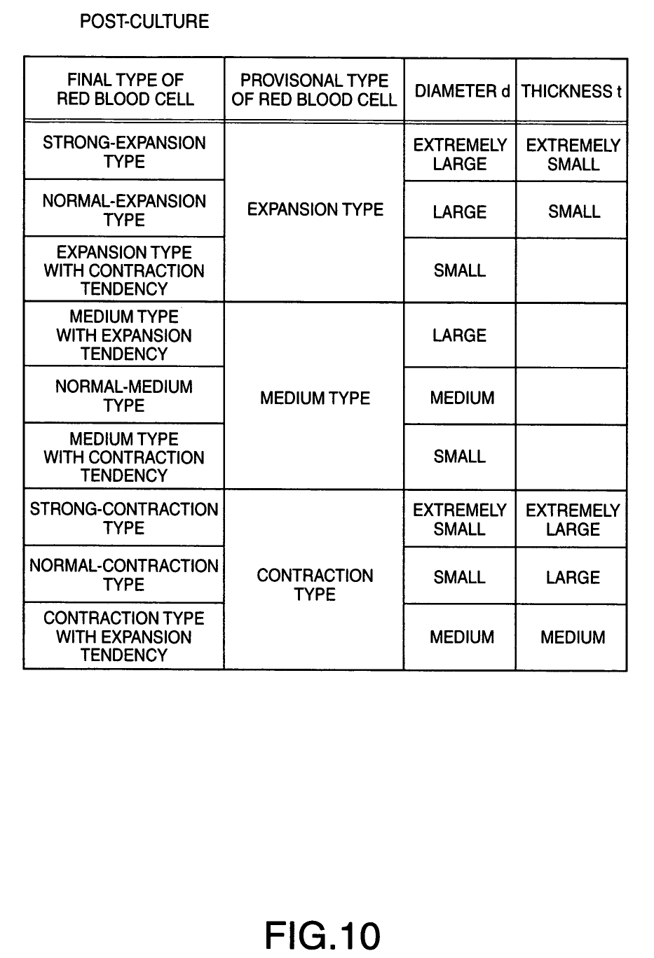

As shown in FIG. 1, data of a post-cultured relationship between features and types of red blood cells has been also stored in the data memory 38. In FIG. 10, the relationship represented by the data of the post-cultured relationship is shown in a table.

According to the relationship represented by the data of the post-cultured relationship between features and types of red blood cells, when the provisional type of the red blood cell is “expansion type,” (a) a strong-expansion type is selected as a final type of the red blood cell, on the condition that there exist not less than a predetermined number of red blood cells in which the rank of the diameter d is “extremely large,” and in which the rank of the thickness t is “extremely small;” (b) a normal-expansion type is selected as a final type of the red blood cell, on the condition that there exist not less than a predetermined number of red blood cells in which the rank of the diameter d is “large,” and in which the rank of the thickness t is “small;” and (c) an expansion type with contraction tendency is selected as a final type of the red blood cell, on the condition that the rank of the diameter d of each red blood cell is “small.”

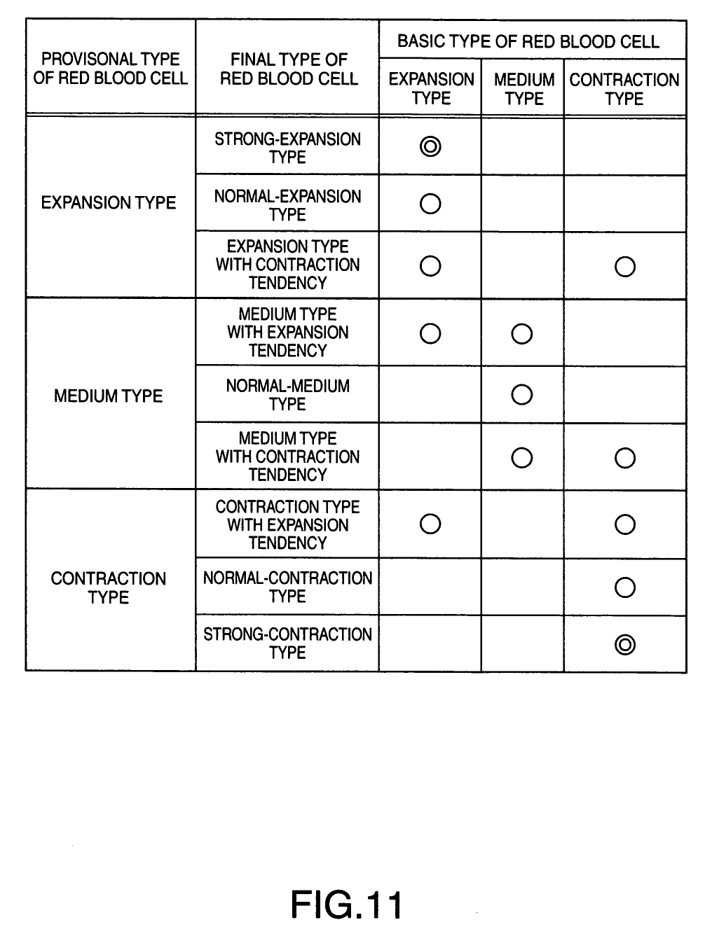

Here, the “expansion type with contraction tendency” refers to, as shown in FIG. 11, a combination type of a red blood cell consisting by combining or binding the expansion and the contraction type which both belong to the basic types of red blood cells.

Alternatively, as shown in FIG. 10, when the provisional type of the red blood cell is “medium type,” (a) a medium type with expansion tendency is selected as a final type of the red blood cell, on the condition that the rank of the diameter d of each red blood cell is “large,” (b) a normal-medium type is selected as a final type of the red blood cell, on the condition that the rank of the diameter d of each red blood cell is “medium,” and (c) an expansion type with contraction tendency is selected as a final type of the red blood cell, on the condition that the rank of the diameter d of each red blood cell is “small.”

Here, the “medium type with expansion tendency” refers to, as shown in FIG. 11, a combination type of a red blood cell consisting by combining or binding the expansion and the medium type which both belong to the basic types of red blood cells.

In addition, the “medium type with contraction tendency” refers to, as shown in FIG. 11, a combination type of a red blood cell consisting by combining or binding the medium and the contraction type which both belong to the basic types of red blood cells.

Additionally, as shown in FIG. 10, when the provisional type of the red blood cell is “contraction type,” (a) a strong-contraction type is selected as a final type of the red blood cell, on the condition that the rank of the diameter d of each red blood cell is “extremely small,” and that the rank of the thickness t is “extremely large,” (b) a normal-contraction type is selected as a final type of the red blood cell type, on the condition that the rank of the diameter d of each red blood cell is “small,” and that the rank of the thickness t is “large,” and (c) a contraction type with expansion tendency is selected as a final type of the red blood cell, on condition that the rank of the diameter d of each red blood cell is “medium,” and that the rank of the thickness t is also “medium.”

Here, the “contraction type with expansion tendency” refers to, as shown in FIG. 11, a combination type of a red blood cell consisting by combining or binding the expansion and the contraction type which both belong to the basic types of red blood cells.

Then, in S25 of FIG. 4, according to the relationship represented by the data of post-cultured relationship between features and types of red blood cells, the current final type of the red blood cell is classified as the same one of the basic types of red blood cells that corresponds to the provisional type of the red blood cell, or as one of a plurality of combination types of red blood cells. The thus determined final type of the red blood cell is stored in the data memory 38.

Then, one cycle of execution of this program for processing image data of red blood cells is terminated.

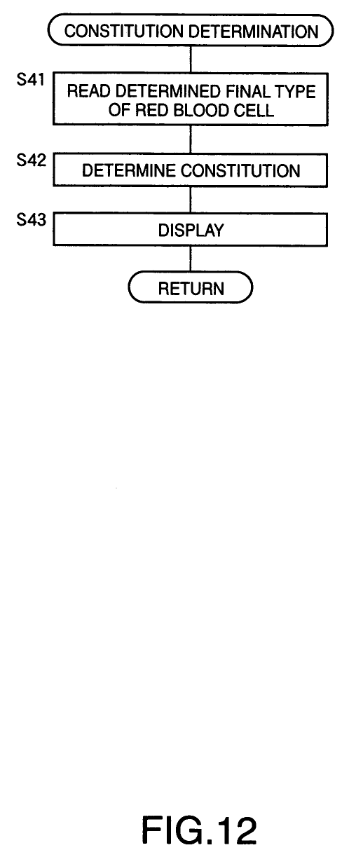

In FIG. 12, the constitution determination program in FIG. 1 is schematically illustrated in a flow chart.

For this constitution determination program, first of all, in S41, the final type of the red blood cell which has been determined as a result of the execution of the program for processing image data of red blood cells is read out from the data memory 38. Next, in S42, depending on the read-out final type of the red blood cell, the constitution of the current user is determined.

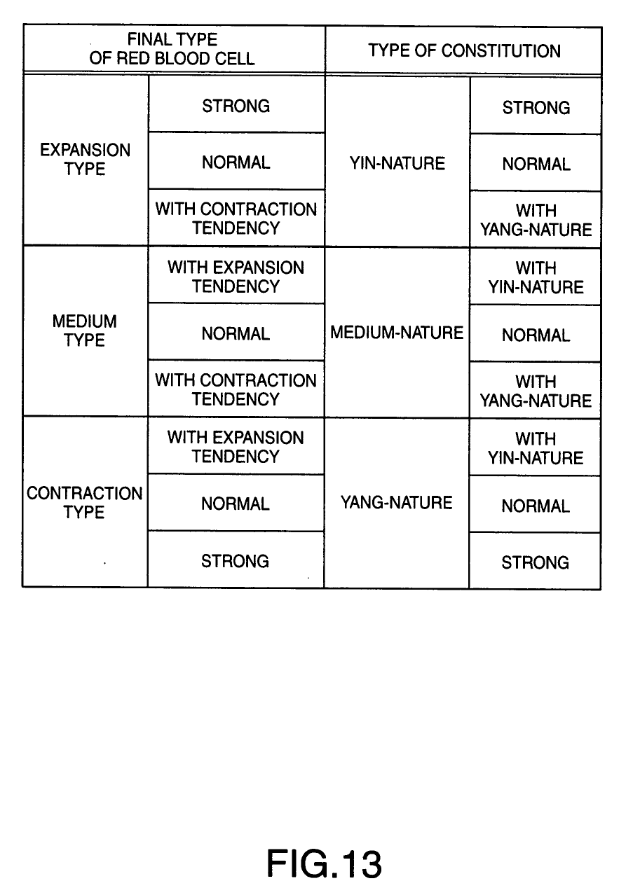

As shown in FIG. 1, the data of relationship between types of red blood cells and types of constitutions has been previously stored in the data memory 38. In FIG. 13, the relationship represented by the data of relationship between types of red blood cells and types of constitutions is illustrated in a table.

According to this relationship, when the final type of the red blood cell is the “strong-expansion type,” the “normal-expansion type,” and the “expansion type with contraction tendency,” respectively, the type of constitution is determined as the “strong yin-nature,” the “normal yin-nature,” and the “yin-nature with yang-nature.”

Here, while the “strong yin-nature” and the “normal yin-nature” both belong to basic types of constitutions, the “yin-nature with yang-nature” belongs to a combination type of constitution consisting by combining the “yin-nature” and the “yang-nature” which both belong to the basic types of constitutions.

Additionally, when the final type of the red blood cell is the “medium type with expansion tendency,” the “normal-medium type,” and the “medium type with contraction tendency,” respectively, the type of constitution is determined as “medium-nature with yin-nature,” the “normal medium-nature,” and the “medium-nature with yang-nature.”

Here, while the “normal medium-nature” belongs to the basic types of constitutions, the “medium-nature with yin-nature” is a combination type of constitution consisting by combining the “yin-nature” and the “medium-nature” which both belong to the basic types of constitutions, and the “medium-nature with yang-nature” is a combination type of constitution consisting by combining the “yang-nature” and the “medium nature” which both belong to the basic types of constitutions.

In addition, when the final type of the red blood cell is the “contraction type with expansion tendency,” the “normal-contraction type,” and the “strong-contraction type,” respectively, the type of constitution is determined as the “yang-nature with yin-nature,” the “normal yang-nature,” and the “strong yang-nature.”

Here, while the “normal yang-nature” and the “strong yang-nature” both belong to the basic types of constitutions, the “yang-nature with yin-nature” is a combination type of constitution consisting by combining the “yin-nature” and the “yang-nature” which both belong to the basic types of constitutions.

Then, in S42 of FIG. 12, according to the relationship represented by the data of relationship between types of red blood cells and types of constitutions, the constitution of the current user is determined as the type of constitution corresponding to the final type of the red blood cell. The thus determined type of constitution is stored in the data memory 38.

Following that, in S43, the thus determined type of constitution is displayed on the screen of the display device 46, and upon request, the final type of the red blood cell is also displayed together.

Then, one cycle of execution of this constitution determination program is terminated.

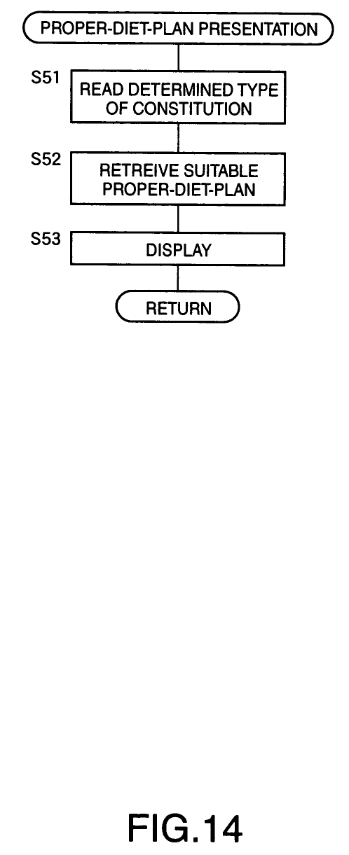

In FIG. 14, the proper-diet-plan presentation program in FIG. 1 is schematically illustrated in a flow chart.

For this proper-diet-plan presentation program, first of all, in S51, the type of constitution which has been determined as a result of the execution of the constitution determination program is read our from the data memory 38.

After that, in S52, a proper-diet-plan that suits the read-out type of constitution is retrieved in the data memory 38.

As shown in FIG. 1, a proper-diet-plan memory 80 is provided with the data memory 38. In the proper-diet-plan memory 80, proper-diet-plan data indicative of a plurality of kinds of proper-diet-plans has been previously stored in association with a plurality of presupposed types of constitutions for an arbitrary user, respectively. The proper-diet-plan data indicative of each kind of proper-diet-plan has been made as data for presenting a diet in the form of a recipe such that it is divided into a staple food, a side dish, and drinkables and liquid foods (including miso-soup, western soup, for example) to the user, wherein the diet suits the user's constitution and contributes to the improvement of the user's constitution toward the medium nature.

Following that, in S52, the thus retrieved proper-diet-plan data is read out from the proper-diet-plan memory 80, and on the basis of the retrieved proper-diet-plan data, the proper-diet-plan that suits the current user's constitution is displayed on the screen of the display device 46.

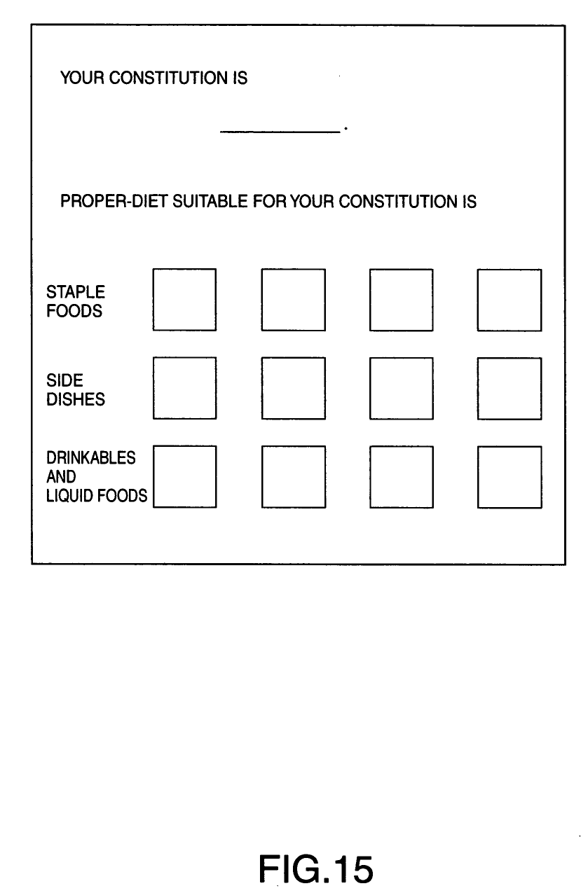

In FIG. 15, one example of the display is illustrated so as to reflect the image on the screen. In this example, the recipe of the diet suitable to the current user's constitution is displayed, together with the constitution, in the form of a combination of a plurality of kinds of candidates of staple foods; a plurality of kinds of candidates of side dishes; and a plurality of kinds of candidates of drinkables and liquid foods.

Then, one cycle of the execution of this proper-diet-plan presentation program is terminated, and as a result, one cycle of the execution of the main program in FIG. 3 is also terminated.

As is evident from the above, in the present embodiment, a portion of the proper-diet-plan presentation system which executes S21 through S23 in FIG. 4 constitutes one example of the “feature extraction means” set forth in the above mode (1), a portion of the proper-diet-plan presentation system which executes S24 and S25 constitutes one example of the “red-blood-cell classification means” set forth in the same mode, and a portion of the proper-diet-plan presentation system which executes S2 in FIG. 3 constitutes one example of the “constitution determination means” set forth in the same mode.

Further, in the present embodiment, the method implemented by the execution of the program for processing image data of red blood cells in FIG. 4 constitutes one example of the “method” set forth in the above mode (16), S21 through S23 in FIG. 4 together constitute one example of the “feature extraction step” set forth in the same mode, S24 and S25 in FIG. 4 together constitute one example of the “red-blood-cell classification step” set forth in the same mode, and S2 in FIG. 3 constitutes one example of the “constitution determination step” set forth in the same mode.

Furthermore, in the present embodiment, a portion of the proper-diet-plan presentation system which executes S24 in FIG. 4 constitutes one example of the “provisional classification portion” set forth in the above mode (5), and S25 in FIG. 4 constitutes one example of the “final classification portion” set forth in the same mode.

Still further, in the present embodiment, a portion of the proper-diet-plan presentation system which executes S32 through S34 in FIG. 5 constitutes one example of the “pattern recognition means” set forth in the above mode (6).

Yet still further, in the present embodiment, a portion of the proper-diet-plan presentation system which executes S52 and S53 in FIG. 14 constitutes one example of the “proper-diet-plan displaying means” set forth in the above mode (11).

Furthermore, in the present embodiment, the program for processing image data of red blood cells in FIG. 4 and the constitution determination program in FIG. 12 together constitute one example of the “program” of the above mode (16).

Still further, in the present embodiment, a portion of the memory 32 in which the program for processing the image data of red blood cells in FIG. 4 has been previously stored, and a portion of the memory 32 in which the constitution determination program in FIG. 12 has been previously stored together constitute one example of the “recording medium” of the above mode (17).

While one embodiment of the present invention has been described above by reference to the drawings, such description is for illustrative purposes, and the present invention may be carried out in alternative embodiments in which various modifications or improvements may be made of the present invention in light of the teachings of those skilled in the art without departing from the sprit of the present invention.

What is claimed is:

1. An apparatus for determining a constitution of a human being, comprising:
a feature extraction means for extracting an outer diameter of a ring-shaped figure corresponding to a diameter of the red blood cell, and a width of the ring-shaped figure corresponding to a thickness of a cell membrane of the red blood cell, as features of a red blood cell in blood of the human being, on the basis of red-blood-cell image data representing a two-dimensional image of the red blood cell which is flat-shaped on a plane and which is enclosed by the cell membrane having the thickness, wherein the red-blood-cell image data is produced for allowing a portion of a cross section of the red blood cell to be obtained by cutting the red blood cell in a direction of the plane, to be visualized as the ring-shaped figure, wherein the portion corresponds to the cell membrane;
a red-blood-cell classification means for classifying the red blood cell as one of a predetermined plurality of types of red blood cells, on the basis of the extracted features, wherein the plurality of types includes an expansion type where a red blood cell exhibits an expansion tendency, a contraction type where a red blood cell exhibits a contraction tendency, and a medium type which is intermediate between the expansion and the contraction type, as three basic types of red blood cells; and
a constitution determination means for determining the constitution of the human being as one of a predetermined plurality of types of constitutions of human beings, on the basis of one of the plurality of types of red blood cells as which the red blood cell has been classified.

2. The apparatus according to claim 1, wherein the plurality of types of red blood cells further includes at least one combination type of a red blood cell combining at least two of the three basic types;
wherein the red-blood-cell image data includes:
first red-blood-cell image data representing an image of a pre-cultured red blood cell, which is picked up using a microscope, after the blood is collected from a body of the human being, and without culturing the red blood cell in the collected blood; and
second red-blood-cell image data representing an image of a post-cultured red blood cell, which is picked up using a microscope, after culturing the red blood cell in the collected blood;
wherein the red-blood-cell classification means includes:
(a) a provisional classification portion for provisionally classifying the red blood cell as one of the three basic types, on the basis of the first red-blood-cell image data, and depending on the outer diameter and the width of the ring-shaped figure indicating the image of the pre-cultured red blood cell; and
(b) a final classification portion for finally classifying the red blood cell as the same one of the basic types as which the red blood cell has been provisionally classified, or one of the at least one combination type, on the premise of one of the basic types as which the red blood cell has been provisionally classified, on the basis of the second red-blood-cell image data, and depending on the outer diameter and the width of the ring-shaped figure indicating the image of the post-cultured red blood cell.

3. The apparatus according to claim 1, wherein the plurality of types of constitutions includes a yin-nature, a yang-nature, and a medium-nature as three basic types of constitutions, and wherein the constitution determination means determines the constitution as the yin-nature, the yang-nature, or the medium-nature, when the red blood cell has been classified as the expansion type, the contraction type, or the medium type, respectively.

4. A method for determining a constitution of a human being, comprising:
a feature extraction step of extracting an outer diameter of a ring-shaped figure corresponding to a diameter of the red blood cell, and a width of the ring-shaped figure corresponding to a thickness of a cell membrane of the red blood cell, as features of a red blood cell in blood of the human being, on the basis of red-blood-cell image data representing a two-dimensional image of the red blood cell which is flat-shaped on a plane and which is enclosed by the cell membrane having the thickness, wherein the red-blood-cell image data is produced for allowing a portion of a cross section of the red blood cell to be obtained by cutting the red blood cell in a direction of the plane, to be visualized as the ring-shaped figure, wherein the portion corresponds to the cell membrane;
a red-blood-cell classification step of classifying the red blood cell as one of a predetermined plurality of types of red blood cells, on the basis of the extracted features, wherein the plurality of types includes an expansion type where a red blood cell exhibits an expansion tendency, a contraction type where a red blood cell exhibits a contraction tendency, and a medium type which is intermediate between the expansion and the contraction type, as three basic types of red blood cells; and
a constitution determination step of determining the constitution of the human being as one of a predetermined plurality of types of constitutions of human beings, on the basis of one of the plurality of types of red blood cells as which the red blood cell has been classified,
wherein the image of red blood cell includes:
an image of a pre-cultured red blood cell, which is picked up using a microscope, after the blood is collected from a body of the human being, and without culturing the red blood cell in the collected blood; and
an image of a post-cultured red blood cell, which is picked up using a microscope, after culturing the red blood cell in the collected blood,
and wherein the red-blood-cell classification step includes:
(a) a provisional classification step of provisionally classifying the red blood cell as one of the three basic types, depending on the outer diameter and the width of the ring-shaped figure indicating the image of the pre-cultured red blood cell; and
(b) a final classification step of finally classifying the red blood cell as the same one of the basic types as which the red blood cell has been provisionally classified, or one of the at least one combination type, on the premise of one of the basic types as which the red blood cell has been classified, and depending on the outer diameter and the width of the ring-shaped figure indicating the image of the post-cultured red blood cell.

5. A program executed by a computer to implement the method according to claim 4.

6. A recording medium which has stored therein the program according to claim 5 in a computer-readable manner.

7. An apparatus for processing red-blood-cell image data representing a two-dimensional image of a red blood cell in blood of a human being, wherein the red blood cell is flat-shaped on a plane and is enclosed by a cell membrane having a thickness, and wherein the red-blood-cell image data is produced for allowing a portion of a cross section of the red blood cell to be obtained by cutting the red blood cell in a direction of the plane, to be visualized as a ring-shaped figure, wherein the portion corresponds to the cell membrane, the apparatus comprising:
a feature extraction means for extracting an outer diameter of the ring-shaped figure corresponding to a diameter of the red blood cell, and a width of the ring-shaped figure corresponding to the thickness of the cell membrane of the red blood cell, as features of the red blood cell, on the basis of the red-blood-cell image data; and
a red-blood-cell classification means for classifying the red blood cell as one of a predetermined plurality of types of red blood cells, on the basis of the extracted features, wherein the plurality of types includes an expansion type where a red blood cell exhibits an expansion tendency, a contraction type where a red blood cell exhibits a contraction tendency, and a medium type which is intermediate between the expansion and the contraction type, as three basic types of red blood cells.
